(19) United States
(12) Patent Application Publication
(10) Pub. No.: US 2026/0260972 A1
(43) Pub. Date: Sep. 3, 2026

(54) ENERGY STORAGE DEVICE AND ENERGY STORAGE APPARATUS

(71) Applicant: GS Yuasa International Ltd., Kyoto-shi (JP)

(72) Inventors: Ryoichi OKUYAMA, Kyoto-shi (JP); Kazuya OKABE, Kyoto-shi (JP)

(21) Appl. No.: 19/655,980

(22) Filed: Apr. 23, 2026

Related U.S. Application Data
(63) Continuation of application No. PCT/JP2024/036944, filed on Oct. 17, 2024.

(30) Foreign Application Priority Data
Oct. 24, 2023 (JP) 2023-182726

(51) Int. Cl. H01M 50/107; H01M 4/02; H01M 4/525; H01M 10/0587; H01M 50/548; H01M 50/55

(52) U.S. Cl. CPC H01M 50/107; H01M 4/525; H01M 10/0587; H01M 50/548; H01M 50/55; H01M 2004/028

(57) ABSTRACT

An energy storage device includes an electrode assembly in which an electrode plate is wound, a case accommodating the electrode assembly, and a pair of terminals in one or more walls of the case. The electrode assembly has a flat shape including a pair of opposing curved portions and a flat portion connecting the pair of curved portions. The case includes a pair of curved wall portions each facing a respective one of the pair of curved portions of the electrode assembly, and flat wall portions each facing both surfaces of the flat portion of the electrode assembly, the pair of curved wall portions are a first curved wall portion and a second curved wall portion, an inner surface of the first curved wall portion and an inner surface of the second curved wall portion each have a curved shape along the curved portions of the electrode assembly.

### CROSS REFERENCE TO RELATED APPLICATIONS

This application claims the benefit of priority to Japanese Patent Application No. 2023-182726 filed on Oct. 24, 2023 and is a Continuation Application of PCT Application No. PCT/JP2024/036944 filed on Oct. 17, 2024. The entire contents of each application are hereby incorporated herein by reference.

### BACKGROUND OF THE INVENTION

### 1. Field of the Invention

The present invention relates to energy storage devices and energy storage apparatuses.

### 2. Description of the Related Art

Conventionally, as disclosed in JP-A-2010-73580, a nonaqueous electrolyte battery is known in which an electrode group, in which a positive electrode including a positive electrode current collector and a positive active material-containing layer and a negative electrode including a negative electrode current collector and a negative active material-containing layer are wound in a flat spiral shape via a separator, is accommodated in a rectangular tubular case.

### SUMMARY OF THE INVENTION

In the nonaqueous electrolyte battery disclosed in JP-A-2010-73580 (hereinafter, referred to as an “energy storage device”), a case is a rectangular tubular (prismatic) case 100z as illustrated as a comparative example in FIG. 1 of the present application, and, as illustrated in FIG. 2 of the present application, an internal space of the case 100z has a rectangular parallelepiped shape. Accordingly, even when an electrode group (hereinafter, referred to as an “electrode assembly”) is accommodated in the case 100z, an inner wall of the case does not follow an outer surface of a curved portion of an electrode assembly 700, and a gap (extra space) is created between the curved portion of the wound (hereinafter, referred to as “wound”) electrode assembly 700 and an inner surface of the case 100z. Specifically, as illustrated in FIG. 3 of the present application, at a corner portion formed by an inner surface of the case parallel to a flat portion 712 of the electrode assembly 700 and an inner surface of the case 100z facing a curved portion 711 of the electrode assembly 700, a gap (a volume loss inside the case due to extra space) is created between the inner surface of the case and the curved portion 711 of the electrode assembly 700. This has been a factor that reduces volumetric energy density inside the energy storage device. On the other hand, in a stacked-type electrode assembly that is not wound, even when accommodated in a rectangular tubular (prismatic) case, extra space inside the case is small, and thus the volumetric energy density inside the energy storage device is less likely to be reduced. However, from the viewpoint of productivity and manufacturing cost, a wound electrode assembly is superior to a stacked-type electrode assembly, and therefore there is a demand for an energy storage device capable of accommodating a flat-shaped wound electrode assembly without impairing volumetric energy density.

Example embodiments of the present invention provide energy storage devices that each accommodates a wound electrode assembly and has increased volumetric energy density within an energy storage device case, and energy storage apparatuses each having increased volumetric energy density.

An energy storage device according to an example embodiment of the present invention includes an electrode assembly in which an electrode plate is wound, a case accommodating the electrode assembly, and a pair of terminals provided in the case, in which the electrode assembly has a flat shape including a pair of opposing curved portions and a flat portion connecting the pair of curved portions, the case includes a pair of curved wall portions each facing a respective one of the pair of curved portions of the electrode assembly, and flat wall portions each facing both surfaces of the flat portion of the electrode assembly, the pair of curved wall portions are a first curved wall portion and a second curved wall portion, an inner surface of the first curved wall portion and an inner surface of the second curved wall portion each have a curved shape along the curved portions of the electrode assembly, inner surfaces of the flat wall portions each have a flat shape along the flat portion of the electrode assembly, and the pair of terminals are provided in one or more of the wall portions of the case, in which a direction approaching from the second curved wall portion toward the first curved wall portion is a direction penetrating from an inner surface to an outer surface of the case, and the pair of terminals protrude in the direction approaching from the second curved wall portion toward the first curved wall portion.

According to example embodiments of the present invention, it is possible to provide energy storage devices in each of which a wound electrode assembly can be accommodated with a reduced volume loss inside a case and in which volumetric energy density inside an energy storage device case is increased, and energy storage apparatuses each having increased volumetric energy density.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an appearance of an energy storage device of a prismatic case according to a comparative example.

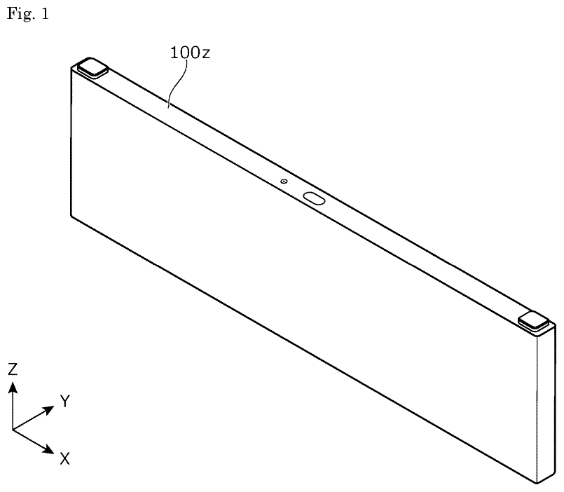

FIG. 2 is an exploded perspective view illustrating respective elements of the energy storage device of a prismatic case according to the comparative example in an exploded manner.

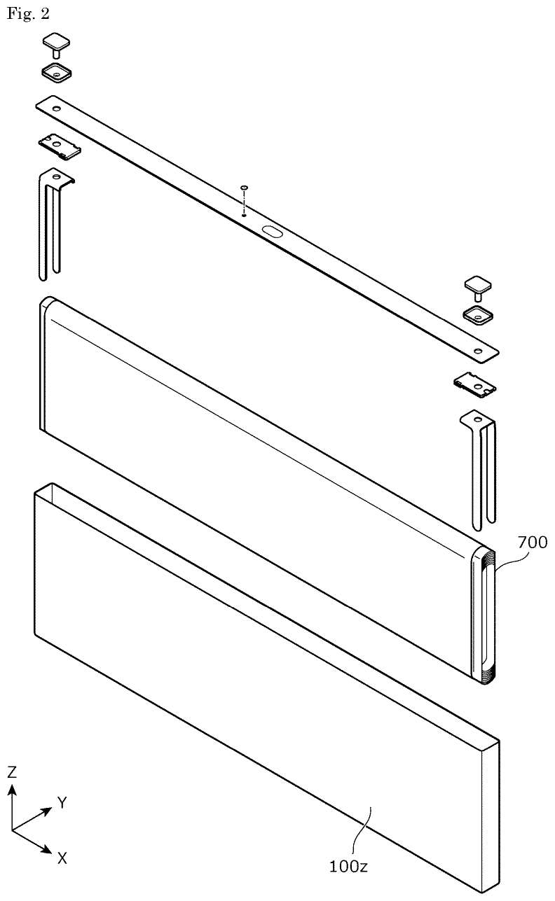

FIG. 3 is a cross-sectional view illustrating a state in which an electrode assembly is accommodated in a prismatic case according to the comparative example.

FIG. 4 is a perspective view illustrating an appearance of an energy storage device according to an example embodiment of the present invention.

FIG. 5 is an exploded perspective view illustrating respective elements of an energy storage device according to an example embodiment in an exploded manner.

FIG. 6 is a perspective view illustrating a configuration of an electrode assembly according to an example embodiment of the present invention.

FIG. 7 is a cross-sectional view illustrating a positional relationship between a case and an electrode assembly according to an example embodiment of the present invention.

FIG. 8 is a cross-sectional view illustrating a positional relationship between a case and an electrode assembly according to Modification Example 1.

FIG. 9 is a perspective view illustrating an appearance of an energy storage device according to Modification Example 2.

FIG. 10 is a perspective view illustrating an appearance of an energy storage device according to Modification Example 3.

FIG. 11 is a plan view illustrating appearances of energy storage devices according to Modification Example 4 and Modification Example 5.

FIG. 12 is a perspective view illustrating an appearance of an energy storage device according to Modification Example 6.

FIG. 13 is a perspective view illustrating an appearance of an energy storage device according to Modification Example 7.

FIG. 14 is a plan view illustrating an appearance of an energy storage device according to Modification Example 8.

FIG. 15 is a perspective view illustrating an appearance of an energy storage apparatus according to an example embodiment of the present invention.

FIG. 16 is an exploded perspective view illustrating respective elements when an energy storage apparatus according to an example embodiment is in an exploded manner.

FIG. 17 is an explanatory view illustrating a holding unit, a case, and each energy storage device according to an example embodiment of the present invention.

### DETAILED DESCRIPTION OF THE EXAMPLE EMBODIMENTS

The inventors conceived that, by causing an inner surface of a wall portion of a case (flat wall portion) facing a flat portion of an electrode assembly to follow a flat shape of the flat portion, and by causing an inner surface of a wall portion of the case (curved wall portion) facing a curved portion of the electrode assembly to follow a curved shape of the curved portion, extra space between the electrode assembly and the case in an energy storage device can be reduced, thereby improving volumetric energy density inside the case of the energy storage device. Further, the inventors conceived incorporating, into the energy storage device, a configuration in which a pair of terminals are provided in one or more wall portions, among wall portions constituting the case, in which a direction approaching from the second curved wall portion toward the first curved wall portion is a direction penetrating from an inner surface to an outer surface of the case, and the pair of terminals protrude in the direction approaching from the second curved wall portion toward the first curved wall portion. Further, by providing terminals on an upper portion of the energy storage device, when the energy storage devices are assembled into an assembly, wiring such as bus bars can be joined from above, thereby improving productivity.

In that, with respect to the above-described case, a configuration in which a pair of terminals are provided in one or more wall portions, among wall portions constituting the case, in which a direction approaching from the second curved wall portion toward the first curved wall portion is a direction penetrating from an inner surface to an outer surface of the case, and in which the pair of terminals are caused to protrude in the direction approaching from the second curved wall portion toward the first curved wall portion is combined, the present invention constitutes an innovative invention that departs from the conventional common knowledge of similar energy storage devices in which providing terminals has conventionally been considered difficult.

(1) An energy storage device according to an example embodiment of the present invention includes an electrode assembly in which an electrode plate is wound, a case accommodating the electrode assembly, and a pair of terminals disposed in the case, in which the electrode assembly has a flat shape including a pair of opposing curved portions and a flat portion connecting the pair of curved portions, the case includes a pair of curved wall portions each facing a respective one of the pair of curved portions of the electrode assembly, and flat wall portions each facing both surfaces of the flat portion of the electrode assembly, the pair of curved wall portions are a first curved wall portion and a second curved wall portion, an inner surface of the first curved wall portion and an inner surface of the second curved wall portion each have a curved shape along the curved portions of the electrode assembly, inner surfaces of the flat wall portions each have a flat shape along the flat portion of the electrode assembly, and the pair of terminals are provided in one or more wall portions, among wall portions constituting the case, in which a direction approaching from the second curved wall portion toward the first curved wall portion is a direction penetrating from an inner surface to an outer surface of the case, and the pair of terminals protrude in the direction approaching from the second curved wall portion toward the first curved wall portion.

According to the energy storage device according to an example embodiment of the present invention described in the above (1), since an inner surface of a case of the energy storage device follows both of a flat portion and a curved portion, which are outer surfaces of an electrode assembly, extra space inside the case of the energy storage device can be made smaller than that in the case of a prismatic case, and a decrease in volumetric energy density inside the case of the energy storage device can be reduced or prevented.

(2) In the energy storage device described in the above (1), in which the pair of terminals may protrude from an outer surface of the first curved wall portion in the direction approaching from the second curved wall portion toward the first curved wall portion.

According to the energy storage device described in the above (2), since the pair of terminals are positioned at an end portion of the energy storage device in the direction approaching from the second curved wall portion toward the first curved wall portion, even after a plurality of energy storage devices are assembled into a unit, outward approach to the terminals is facilitated. Accordingly, electrical connection (such as welding) between the terminals and bus bars or the like is facilitated.

(3) In the energy storage device described in the above (1), in which the case may include a pair of notches positioned relative to each other in a winding axis direction of the electrode assembly, the pair of notches may be provided at positions sandwiching the first curved wall portion of the case in the winding axis direction, and the pair of terminals may be located within the pair of notches and on a surface in which the direction approaching from the second curved wall portion toward the first curved wall portion is the direction penetrating from the inner surface of the case to the outer surface of the case, and the pair of terminals protrude in the direction approaching from the second curved wall portion toward the first curved wall portion.

According to the energy storage device described in the above (3), since the pair of terminals are provided within the pair of notches, on a surface in which a direction approaching from the second curved wall portion toward the first curved wall portion is a direction penetrating from an inner surface of the case to an outer surface of the case, and further since the pair of terminals are provided so as to protrude in the direction approaching from the second curved wall portion toward the first curved wall portion, an amount of protrusion of the terminals in a direction in which the pair of curved portions face each other can be reduced or prevented. That is, by disposing the terminals within the notches, a volume of the energy storage device including the terminals is reduced, and the volumetric energy density becomes higher than in a case where the terminals are provided on the curved wall portions.

(4) In the energy storage device described in the above (1), the device may include a pair of first terminals and a pair of second terminals provided in the case, in which the pair of first terminals are the pair of terminals, the pair of first terminals may protrude from an outer surface of the first curved wall portion in a direction approaching from the second curved wall portion toward the first curved wall portion, and the pair of second terminals may protrude from an outer surface of the second curved wall portion in the direction approaching from the first curved wall portion toward the second curved wall portion.

According to the energy storage device described in the above (4), since a pair of terminals (a pair of first terminals and a pair of second terminals) protrude from outer surfaces of respective curved wall portions (a first curved wall portion and a second curved wall portion) of the case, volumetric energy density of the energy storage device can be increased as compared with a case where a pair of terminals protrude from respective end portions of the case in a winding axis direction. Further, since the pair of first terminals are positioned at an end portion of the energy storage device in a direction approaching from the second curved wall portion toward the first curved wall portion, and the pair of second terminals are positioned at an end portion of the energy storage device in a direction approaching from the first curved wall portion toward the second curved wall portion, even after a plurality of energy storage devices are assembled into a unit, outward approach to the terminals is facilitated. Accordingly, electrical connection (such as welding) between the terminals and bus bars or the like is facilitated. Further, since the energy storage device includes two pairs of terminals (a pair of first terminals and a pair of second terminals), a current can be efficiently taken out from the energy storage device. That is, by configuring the energy storage device to have a four-terminal structure, resistance can be reduced, and the energy storage device exhibits excellent power performance.

(5) In the energy storage device described in the above (1), the device may include a pair of first terminals and a pair of second terminals provided in the case, in which the pair of first terminals may be the pair of terminals, the case may include a pair of first notches and a pair of second notches, the pair of first notches may be located at positions sandwiching the first curved wall portion of the case in a winding axis direction of the electrode assembly, the pair of second notches may be located at positions sandwiching the second curved wall portion of the case in the winding axis direction, the pair of first terminals may be located within the pair of first notches and on a surface in which the direction approaching from the second curved wall portion toward the first curved wall portion is the direction penetrating from the inner surface of the case to the outer surface of the case and the pair of first terminals may protrude in the direction approaching from the second curved wall portion toward the first curved wall portion, and the pair of second terminals may be located within the pair of second notches and on a surface in which a direction approaching from the first curved wall portion toward the second curved wall portion is a direction penetrating from the inner surface of the case to the outer surface of the case and the pair of second terminals protrude in the direction approaching from the first curved wall portion toward the second curved wall portion.

According to the energy storage device described in the above (5), since the pair of first terminals are provided to protrude, within the pair of first notches, in the direction approaching from the second curved wall portion toward the first curved wall portion, an amount of outward protrusion of the pair of first terminals of the case in the direction approaching from the second curved wall portion toward the first curved wall portion can be reduced or prevented. Similarly, since the pair of second terminals are provided to protrude, within the pair of second notches, in the direction approaching from the first curved wall portion toward the second curved wall portion, an amount of outward protrusion of the pair of second terminals of the case in the direction approaching from the first curved wall portion toward the second curved wall portion can be reduced or prevented. As described above, since the energy storage device includes two pairs of terminals (a pair of first terminals and a pair of second terminals), a current can be efficiently taken out from the energy storage device. That is, by configuring the energy storage device to have a four-terminal structure, resistance can be reduced, and the energy storage device can exhibit excellent power performance. Further, by providing the terminals within the notches (the pair of first notches and the pair of second notches), a volume of the energy storage device including the terminals can be reduced, and volumetric energy density of the energy storage device can be increased as compared with a case where the terminals are provided on the curved wall portions.

(6) In the energy storage device described in any one of the above (1) to (5), in which the electrode plate may include a positive active material, the positive active material may include a lithium transition metal composite oxide having an α-NaFeO₂ type crystal structure and including a nickel element, and a content of the nickel element with respect to transition metal elements included in the lithium transition metal composite oxide may be about 50 mol % or more.

It is known that, in a wound electrode assembly using an electrode plate in which a positive active material of the wound electrode assembly includes a lithium transition metal composite oxide having an α-NaFeO₂ type crystal structure and including a nickel element, and in which a content of the nickel element with respect to transition metal elements included in the lithium transition metal composite oxide is about 50 mol % or more, volumetric energy density of the positive active material is increased, while expansion of a curved portion of the electrode assembly due to charge-discharge becomes significant. In an energy storage device in which a flat-shaped wound electrode assembly including such a positive active material is accommodated in a rectangular tubular (prismatic) case, extra space between a curved portion of the electrode assembly and an inner surface of the case is relatively large, and expansion of the curved portion of the electrode assembly tends to progress more significantly.

In particular, in an energy storage apparatus in which a plurality of energy storage devices are assembled, it is common to restrain a flat portion of an electrode assembly, and in a battery in which the flat portion is restrained, expansion of the flat portion is reduced or prevented. For this reason, a boundary portion between a flat portion whose expansion is reduced or prevented and a curved portion of an electrode assembly using an electrode in which a content of a nickel element is set to about 50 mol % or more and expansion is large forms high strain, and the electrode may be damaged, thereby significantly reducing safety. In contrast, according to the energy storage device described in the above (6), extra space inside the case can be made smaller than that in the case of a prismatic case, and even when a positive active material having high volumetric energy density is used, expansion of the electrode assembly at a curved portion can be reduced or prevented, thereby providing an energy storage device. Therefore, according to the energy storage device described in the above (6), an effect of improving volumetric energy density inside the case of the energy storage device and, further, exhibiting excellent safety is remarkably achieved.

(7) An energy storage apparatus including the energy storage device described in any one of the above (1) to (6) may also be provided.

According to the energy storage apparatus described in the above (7), since the energy storage apparatus includes the above-described energy storage device, the energy storage apparatus can be configured to have increased volumetric energy density.

Hereinafter, energy storage devices and energy storage apparatuses according to example embodiments of the present invention (including modification examples thereof) will be described with reference to the drawings. Each of the example embodiments described below illustrates a comprehensive or specific example. Numerical values, shapes, materials, elements, arrangement positions and connection forms of the elements, manufacturing processing, orders of the manufacturing processing, and the like shown in the example embodiments described below are merely examples, and are not intended to limit the present invention. In each drawing, dimensions and the like are not illustrated strictly. In each drawing, the same or similar elements are denoted by the same reference numerals. Names of respective members (respective elements) in the present example embodiment are those used in the present example embodiment, and may differ from names of respective members (respective elements) in the background art.

In the following description and drawings, a longitudinal direction of an energy storage device and a winding axis direction of an electrode assembly provided in the energy storage device are defined as an X-axis direction. A direction in which a plurality of energy storage devices are arranged, a thickness direction of a case of the energy storage device, an opposing direction of a pair of flat portions of the electrode assembly, and an opposing direction of a pair of flat wall portions of the case are defined as a Y-axis direction. A direction in which a case lid body and a case main body of an energy storage apparatus are arranged, an opposing direction of a pair of curved portions of the electrode assembly, an opposing direction of a pair of curved wall portions of the case, or an up-down direction is defined as a Z-axis direction. The X-axis direction, the Y-axis direction, and the Z-axis direction intersect with each other (orthogonal to each other in the present example embodiment). Depending on a usage case, the Z-axis direction may not be an up-down direction; however, for convenience of description, the Z-axis direction will be described as the up-down direction below.

In the following description, in a case where the term “insulation” is used, it means “electrical insulation”. A material having insulating properties is preferably formed from a material having a volume resistivity of 1×10¹⁰ Ω·m or more.

In the following description, a positive direction of the X-axis indicates a direction of an arrow of the X-axis, and a negative direction of the X-axis indicates a direction opposite to the positive direction of the X-axis. The same applies to the Y-axis direction and the Z-axis direction. The positive direction of the Z-axis can be exemplified as a direction approaching from a second curved wall portion of the case toward a first curved wall portion of the case, and the negative direction of the Z-axis can be exemplified as a direction approaching from a second curved wall portion of the case toward a first curved wall portion of the case. Further, expressions indicating relative directions or orientations, such as parallel and orthogonal, also include cases that are not strictly such directions or orientations. That two directions are orthogonal means not only that the two directions are completely orthogonal, but also that the two directions are substantially orthogonal, that is, include differences on the order of several percent.

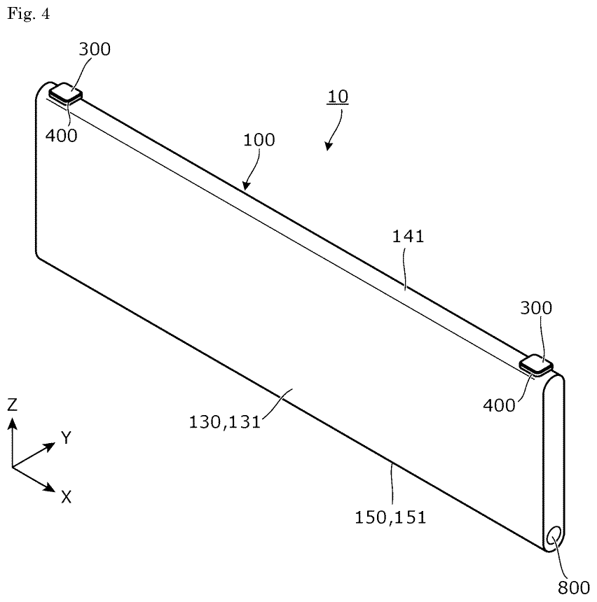

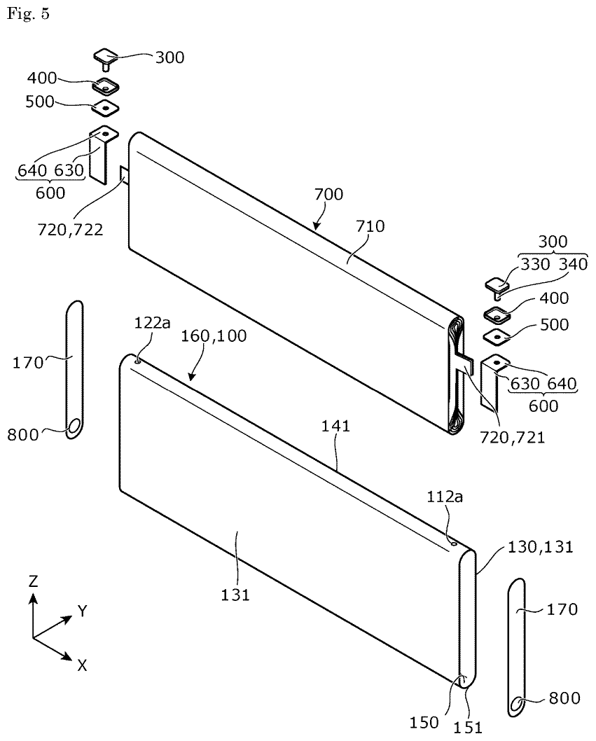

A general description of an energy storage device 10 according to the present example embodiment will be given with reference to FIGS. 4 and 5. FIG. 4 is a perspective view illustrating an appearance of the energy storage device 10 according to the present example embodiment. FIG. 5 is an exploded perspective view illustrating respective elements of the energy storage device 10 according to the present example embodiment in an exploded manner.

The energy storage device 10 is an energy storage device capable of charging electricity from outside and discharging electricity to the outside. The energy storage device 10 is not limited to a nonaqueous electrolyte secondary battery, and may be a secondary battery other than a nonaqueous electrolyte secondary battery, or may be a capacitor. The energy storage device 10 may be a primary battery, rather than a secondary battery, from which stored electricity can be used without charging by a user. Further, the energy storage device 10 may be an all-solid-state battery using a solid electrolyte, or a polymer battery. The energy storage device 10 may also be a pouch-type energy storage device. In the present example embodiment, the energy storage device 10 based on a flat, elongated cylindrical shape is illustrated; however, a shape of the energy storage device 10, that is, a shape of a case 100, is not limited to a shape based on a flat, elongated cylindrical shape. As long as an inner surface of the case 100 has a shape following an outer surface of an electrode assembly 700 described below, a shape based on a polygonal column shape, an elliptical column shape, a cylindrical shape, or the like may be employed.

As illustrated in FIGS. 4 and 5, in the present example embodiment, the energy storage device 10 includes the case 100, a pair of terminals 300, and a pair of external gaskets 400. Further, the energy storage device 10 includes, inside the case 100, a pair of internal gaskets 500, a pair of current collectors 600, and the electrode assembly 700. The case 100 includes a lid body 170 that covers an end portion in the positive direction of the X-axis and the lid body 170 that covers an end portion in the negative direction of the X-axis. An outer surface of the lid body 170 in the positive direction of the X-axis is referred to as a first side surface portion 110, and an outer surface of the lid body 170 in the negative direction of the X-axis is referred to as a second side surface portion 120.

An electrolyte solution (nonaqueous electrolyte) is sealed inside the case 100; however, illustration thereof is omitted. A type of the electrolyte solution is not particularly limited as long as it does not impair performance of the energy storage device 10. In addition to the above-described elements, spacers may be disposed on a side, an upper side, or a lower side of the electrode assembly 700, and an insulation film or the like that surrounds the electrode assembly 700 and the like may also be disposed.

The case 100 is a case having an outer shape of an elongated cylindrical shape that is long in the X-axis direction and flat in the Y-axis direction. In the present example embodiment, a length of the case 100 in the X-axis direction is three times or more a length of the case 100 in the Z-axis direction, and the length of the case 100 in the X-axis direction is five times or more a length of the case 100 in the Y-axis direction.

The case 100 includes a case main body 160 and the pair of lid bodies 170, and by assembling the case main body 160 and the respective lid bodies 170, the case 100 has a cylindrical shape that is long in the X-axis direction. The case main body 160 includes a pair of flat wall portions 131 and a pair of curved wall portions 141 and 151 (first curved wall portion 141 and second curved wall portion 151), and the pair of flat wall portions 131 and the pair of curved wall portions 141 and 151 form a cylindrical shape that extends through in the X-axis direction and is long in the X-axis direction. Each of the pair of lid bodies 170 is a plate-shaped member that closes a respective end portion of the case main body 160 in the X-axis direction, and is included in wall portions of the case 100. The lid body 170 positioned in the negative direction of the X-axis closes an end portion of the case main body 160 in the negative direction of the X-axis, and the lid body 170 positioned in the positive direction of the X-axis closes an end portion of the case main body 160 in the positive direction of the X-axis.

A gas release valve 800 (see FIGS. 4 and 5) is disposed on the lid body 170 positioned in the positive direction of the X-axis. Specifically, the gas release valve 800 is disposed at a position in the negative direction of the Z-axis on the lid body 170 positioned in the positive direction of the X-axis. The gas release valve 800 is a safety valve that releases pressure in a case where pressure inside the case 100 excessively increases.

With such a configuration, the case 100 has a structure in which, after the electrode assembly 700 and the like are accommodated inside the case main body 160, the case main body 160 and the lid body 170 are joined by welding or the like, thereby sealing an interior thereof. A material of the case 100 (the case main body 160 and the lid body 170) is not particularly limited; however, weldable metals such as stainless steel, aluminum, aluminum alloys, iron, plated steel sheets, and the like are preferable.

Although not illustrated here, an electrolyte solution filling portion is formed in the case main body 160 or the lid body 170. The electrolyte solution filling portion is a portion for injecting an electrolyte solution into the interior of the case 100 during manufacture of the energy storage device 10.

Each of the pair of curved wall portions 141 and 151 is a wall portion that is long in the X-axis direction and faces a curved portion 711 of the electrode assembly 700. That is, the pair of curved wall portions 141 and 151 can also be considered to respectively face the pair of curved portions 711. An inner surface of each of the curved wall portions 141 and 151 has a curved shape to follow the curved portion 711 of the electrode assembly 700. Specifically, an inner surface of the first curved wall portion 141, which is the curved wall portion 141 positioned in the positive direction of the Z-axis, is curved to be recessed in the positive direction of the Z-axis, and an inner surface of a second curved wall portion 151, which is the curved wall portion 151 positioned in the negative direction of the Z-axis, is curved to be recessed in the negative direction of the Z-axis. In the present example embodiment, outer surfaces of the respective curved wall portions 141 and 151 are also curved, the first curved wall portion 141 is formed in a curved shape protruding in the positive direction of the Z-axis, and the second curved wall portion 151 is formed in a curved shape protruding in the negative direction of the Z-axis. Each flat wall portion 131 of the pair of flat wall portions 131 is a wall portion that is long in the X-axis direction and faces a flat portion 712 of the electrode assembly in the Y-axis direction. That is, the flat wall portions 131 can also be considered to respectively face both surfaces of the flat portion 712. Each flat wall portion 131 is formed in a flat plate shape parallel to an XZ plane, and an inner surface of the flat wall portion 131 has a flat shape to follow the flat portion 712 of the electrode assembly 700.

In the case main body 160, an outer surface of each flat wall portion 131 includes a long side surface 130, an outer surface of the first curved wall portion 141 which is curved wall portion 141 in the positive direction of the Z-axis includes a top surface 140, and an outer surface of the second curved wall portion 151 which is curved wall portion 151 in the negative direction of the Z-axis includes the bottom surface 150. The long side surfaces 130 are surfaces elongated in the X-axis direction and parallel to the XZ plane, and the pair of long side surfaces 130 face each other in the Y-axis direction. A top surface 140 is a surface that is elongated in the X-axis direction and is curved to be recessed in a positive direction of the Z-axis along the curved portion 711 of the electrode assembly 700, and is positioned in a positive direction of the Z-axis relative to the long side surface 130. A bottom surface 150 is a surface that is elongated in the X-axis direction and is curved to be recessed in a negative direction of the Z-axis along the curved portion 711 of the electrode assembly 700, and is positioned in a negative direction of the Z-axis relative to the long side surface 130.

The lid body 170 of the pair of lid bodies 170 in the positive direction of the X-axis includes the first side surface portion 110 which is an outer surface parallel to the YZ plane. The lid body 170 of the pair of lid bodies 170 in the negative direction of the X-axis includes the second side surface portion 120 which is an outer surface parallel to the YZ plane.

The terminals 300 are terminals (positive electrode terminal and negative electrode terminal) that are electrically connected to the electrode assembly 700 via the current collectors 600. That is, the terminals 300 are metal members for leading electricity stored in the electrode assembly 700 to an external space of the energy storage device 10, or for introducing electricity into an internal space of the energy storage device 10 in order to store electricity in the electrode assembly 700. A material of the terminals 300 is not particularly limited; however, the terminals 300 are formed of conductive members such as aluminum, aluminum alloys, copper, or copper alloys. The terminals 300 are connected (joined) to the current collectors 600 by caulking, welding, or the like, and are attached to the lid bodies 170.

The energy storage device 10 of the present example embodiment includes the pair of terminals 300. Each terminal 300 includes a terminal main body portion 330 and a shaft portion 340 protruding from the terminal main body portion 330. The terminal main body portion 330 is a portion that protrudes outward from a terminal installation surface of the case 100. In the present example embodiment, an outer surface of the first curved wall portion 141 includes the terminal installation surface, and each terminal 300 of the pair of terminals 300 and each external gasket 400 are disposed on the outer surface of the first curved wall portion 141 of the case 100. Each terminal 300 protrudes in the positive direction of the Z-axis from the outer surface of the first curved wall portion 141 of the case 100. Here, the first curved wall portion 141 is one wall portion among wall portions constituting the case 100 in which a direction approaching from the second curved wall portion 151 toward the first curved wall portion 141 is a direction penetrating from an inner surface to an outer surface of the case 100.

In the terminal installation surface of the first curved wall portion 141, through holes 112a and 122a through which the shaft portion 340 penetrates are formed. With the shaft portion 340 caulked in a state of penetrating through the first curved wall portion 141, the external gasket 400, the internal gasket 500, and the current collector 600, the terminal 300 and the current collector 600 are connected (joined).

In the present example embodiment, the terminal main body portion 330 protrudes outward of the case 100 in the positive direction of the Z-axis from the terminal installation surface; in other words, the terminal main body portion 330 protrudes in a direction approaching from the second curved wall portion 151 of the case 100 toward the first curved wall portion 141.

The current collectors 600 are each disposed at one of respective end portions of the electrode assembly 700 in the X-axis direction. The current collectors 600 are conductive members (positive electrode current collector and negative electrode current collector) that are connected (joined) to the electrode assembly 700 and the terminals 300 to electrically connect the electrode assembly 700 and the terminals 300. The current collectors 600 integrally include a first joint portion 630 and a second joint portion 640. Specifically, the first joint portion 630 of the current collector 600 and a tab portion 720 of the electrode assembly 700 described later are connected (joined) by welding, caulking, or the like, and the second joint portion 640 of the current collector 600 and the terminal 300 are connected (joined) by caulking, welding, or the like. The first joint portion 630 and the second joint portion 640 are each flat plate-shaped portions, and are formed by bending a single sheet metal. Although a material of the current collectors 600 is not particularly limited, in the present example embodiment, the positive electrode current collector is formed of a conductive member such as aluminum or aluminum alloys, and the negative electrode current collector is formed of a conductive member such as copper or a copper alloy.

The external gasket 400 is disposed between the first curved wall portion 141 of the case 100 and the terminal 300, and is a member that insulates between the first curved wall portion 141 and the terminal 300 and seals the interior of the case 100. In the present example embodiment, the external gasket 400 is a plate-shaped, rectangular insulating member. The internal gasket 500 is disposed between the lid body 170 and the current collector 600, and is a member that insulates between the first curved wall portion 141 and the current collector 600 and seals the interior of the case 100. In the present example embodiment, both the external gasket 400 and the internal gasket 500 are plate-shaped, rectangular insulating members. Materials of the external gasket 400 and the internal gasket 500 may be resins having electrical insulating properties, such as polypropylene (PP), polyethylene (PE), polystyrene (PS), ABS resin, or composite materials thereof.

The electrode assembly 700 is an energy storage element (power generating element) formed by winding electrode plates. The electrode assembly 700 includes a shape of an elongated cylindrical form extending in the X-axis direction. In the present example embodiment, since a length of the electrode assembly 700 in the Y-axis direction is smaller than lengths of the electrode assembly 700 in the X-axis direction and the Z-axis direction, the electrode assembly 700 has a flat shape (a flattened shape) in the Y-axis direction. The electrode assembly 700 has a length in the X-axis direction of 300 mm or more, specifically, about 500 mm to 1500 mm. The length of the electrode assembly 700 in the X-axis direction is greater than a length of the electrode assembly 700 in the Z-axis direction, and the length of the electrode assembly 700 in the X-axis direction is three times or more the length of the electrode assembly 700 in the Z-axis direction. The electrode assembly 700 includes a main body portion 710 and the plurality of tab portions 720 protruding from the main body portion 710, and as described above, the tab portions 720 are connected (joined) to the current collectors 600.

In the present example embodiment, the plurality of tab portions 720 protrude one by one from both end surfaces of the main body portion 710 in the X-axis direction. A positive electrode tab portion 721 is provided on an end surface (one end surface) of the main body portion 710 in the positive direction of the X-axis, and a negative electrode tab portion 722 is provided on an end surface (the other end surface) of the main body portion 710 in the negative direction of the X-axis.

Such an energy storage device 10 is manufactured by the following manufacturing method. First, the case main body 160 is formed by extrusion molding, or by rolling sheet metal and welding end portions thereof in the Z-axis direction. The case main body 160 may also be formed by welding a plurality of divided bodies divided in an XY plane. Next, the electrode assembly 700 is inserted into the case main body 160. After the insertion, the current collectors 600 are connected to the respective tab portions 720. Next, the external gaskets 400, the internal gaskets 500, the first curved wall portion 141, and the terminals 300 are assembled to the respective current collectors 600, and then the lid bodies 170 are welded to both end portions of the case main body 160. Thereafter, electrolyte solution filling is performed to inject an electrolyte solution into the interior of the case 100 from an electrolyte solution filling portion, and the electrolyte solution filling portion is sealed.

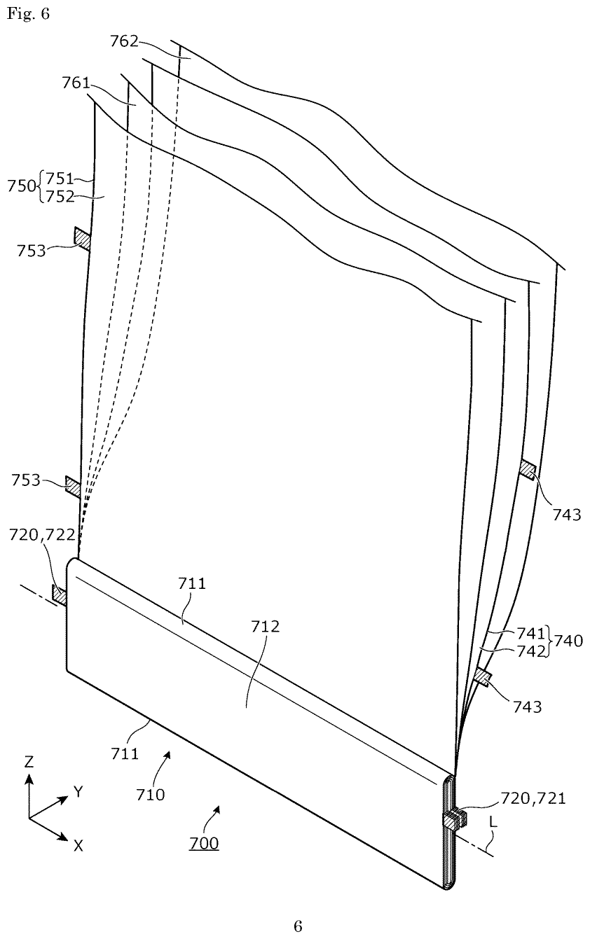

FIG. 6 is a perspective view illustrating a configuration of the electrode assembly 700 according to the present example embodiment. Specifically, FIG. 6 illustrates a state in which winding of electrode plates in the electrode assembly 700 is partially developed. As illustrated in FIG. 6, the electrode assembly 700 includes a positive electrode plate 740, a negative electrode plate 750, and separators 761 and 762.

The positive electrode plate 740 is an electrode plate (electrode sheet) in which a positive active material layer 742 is disposed on a surface of positive electrode current collector foil 741 that is a long strip-shaped metal foil. Aluminum, an aluminum or aluminum alloys, and the like are used for the positive electrode current collector foil 741. The negative electrode plate 750 is an electrode plate (electrode sheet) in which a negative active material layer 752 is disposed on a surface of negative electrode current collector foil 751 that is a long strip-shaped metal foil. Copper, a copper alloy, or the like is used for the negative electrode current collector foil 751. As a positive active material used for the positive active material layer 742 and a negative active material used for the negative active material layer 752, known materials can be appropriately used as long as the materials are capable of occluding and releasing lithium ions.

Examples of the positive active material include polyanion compounds such as LiMPO₄, LiMSiO₄, and LiMBO₃ (where M is one or two or more transition metal elements selected from Fe, Ni, Mn, Co, and the like), lithium titanate, lithium transition metal composite oxides having a spinel-type crystal structure such as LiMn₂O₄ and LiMn_{1.5}Ni_{0.5}O₄, and lithium transition metal oxides having an α-NaFeO₂ type crystal structure such as LiMO₂ (where M is one or two or more transition metal elements selected from Fe, Ni, Mn, Co, and the like). Examples of the negative active material include lithium metal, alloys capable of occluding and releasing lithium, carbon materials (graphite, non-graphitizable carbon, easily graphitizable carbon, low-temperature fired carbon, amorphous carbon, and the like), and silicon oxides.

The positive active material layer may include, as necessary, optional components such as other positive active materials in addition to those described above, a conductive agent, a binder, a thickener, a filler, and the like. As the positive active material, a lithium transition metal composite oxide having an α-NaFeO₂ type crystal structure is preferable. The lithium transition metal composite oxide having the α-NaFeO₂ type crystal structure preferably includes at least one selected from nickel, cobalt, and manganese, and more preferably includes nickel. The lithium transition metal composite oxide preferably includes nickel and manganese, and more preferably includes nickel, cobalt, and manganese. Here, in a case where the positive active material includes a lithium transition metal composite oxide having an α-NaFeO₂ type crystal structure and including a nickel element, it is preferable, from the viewpoint of increasing volumetric energy density of the electrode assembly 700, that a content of the nickel element with respect to transition metal elements included in the lithium transition metal composite oxide is about 50 mol % or more, for example. By using such a lithium transition metal composite oxide, volumetric energy density of the energy storage device 10 can be further increased. The lithium transition metal composite oxide may include only a nickel element as a transition metal element, may include only nickel and manganese, or may include only nickel, cobalt, and manganese. The lithium transition metal composite oxide may further include other metal elements such as aluminum. The positive active material layer may further include other positive active materials in addition to the lithium transition metal composite oxide having an α-NaFeO₂ type crystal structure. As other positive active materials, various conventionally known positive active materials can be used. However, a content of the lithium transition metal composite oxide with respect to all positive active materials included in the positive active material layer is preferably 90 mass % or more, more preferably 99 mass % or more, and still more preferably 100 mass %. As described above, by mainly using the lithium transition metal composite oxide as the positive active material, volumetric energy density of the nonaqueous electrolyte energy storage device can be further increased.

The separators 761 and 762 are microporous sheets made of resin. As materials of the separators 761 and 762, known materials can be appropriately used as long as they do not impair performance of the energy storage device 10. As the separators 761 and 762, woven fabrics insoluble in organic solvents, nonwoven fabrics, synthetic resin microporous membranes made of polyolefin resins such as polyethylene, or the like may be used.

The electrode assembly 700 is formed by winding the positive electrode plate 740, the negative electrode plate 750, and the separators 761 and 762. The electrode assembly 700 is formed by stacking the negative electrode plate 750, the separator 761, the positive electrode plate 740, and the separator 762 in this order and winding the stacked layers. In the present example embodiment, the wound electrode assembly 700 is formed by winding the positive electrode plate 740, the negative electrode plate 750, and the separators 761 and 762 around a winding axis L extending in the X-axis direction. The winding axis L is a virtual axis serving as a center axis when winding the positive electrode plate 740, the negative electrode plate 750, and the separators 761 and 762. In the present example embodiment, the winding axis is a straight line that passes through a center of the electrode assembly 700, is parallel to the X-axis direction, and is perpendicular to the Y-axis direction and the Z-axis direction.

At an end edge of the positive electrode plate 740 in the positive direction of the X-axis, a plurality of protruding pieces 743 protruding outward are disposed at intervals. Similarly, at an end edge of the negative electrode plate 750 in the negative direction of the X-axis, a plurality of protruding pieces 753 protruding outward are disposed at intervals. Each of the protruding pieces 743 among the plurality of protruding pieces 743 is a portion in which the positive active material layer is not provided and the positive electrode current collector foil 741 is exposed (a positive active material layer non-formation portion). Each of the protruding pieces 753 among the plurality of protruding pieces 753 is a portion in which the negative active material layer is not provided and the negative electrode current collector foil 751 is exposed (a negative active material layer non-formation portion). In FIG. 6, the active material layer non-formation portions (the positive active material layer non-formation portion and the negative active material layer non-formation portion) are indicated by hatching.

When the positive electrode plate 740 and the negative electrode plate 750, and the separators 761 and 762 are wound, at an end surface (one end surface) of the main body portion 710 in the positive direction of the X-axis, the plurality of protruding pieces 743 of the positive electrode plate 740 overlap with each other, and at an end surface (the other end surface) in the negative direction of the X-axis, the plurality of protruding pieces 753 of the negative electrode plate 750 overlap with each other. A portion of the positive electrode plate 740 where the plurality of protruding pieces 743 overlap with each other constitutes the positive electrode tab portion 721. That is, the positive electrode tab portion 721 is a portion in which a plurality of pieces (protruding pieces 743) provided in electrode plates of the same polarity (positive electrode plates 740) among a plurality of electrode plates (the positive electrode plates 740 and the negative electrode plates 750) are stacked.

Similarly, a portion of the negative electrode plate 750 where the plurality of protruding pieces 753 overlap with each other constitutes a negative electrode tab portion 722. That is, the negative electrode tab portion 722 is a portion in which a plurality of pieces (protruding pieces 753) provided in electrode plates of the same polarity (negative electrode plates 750) among a plurality of electrode plates (the positive electrode plates 740 and the negative electrode plates 750) are stacked.

As described above, the electrode assembly 700 includes the main body portion 710 that constitutes a main body of the electrode assembly 700, and the tab portions 720 (positive electrode tab portion 721 and negative electrode tab portion 722) protruding from respective end surfaces of the main body portion 710 in the X-axis direction. In other words, the electrode assembly 700 includes a pair of tab portions composed of the positive electrode tab portion 721 and the negative electrode tab portion 722.

The main body portion 710 is an oblong cylindrical portion formed by winding portions of the positive electrode plate 740 on which the positive active material layer 742 is disposed (formed, coated), portions of the negative electrode plate 750 on which the negative active material layer 752 is disposed (formed, coated), and the separators 761 and 762. In the main body portion 710, a region in which at least one of the positive active material layer 742 and the negative active material layer 752 is stacked is referred to as an active material layer formation portion. An outer surface of the main body portion 710 includes the curved portions 711 at both end portions in the Z-axis direction and the flat portions 712 at both end portions in the Y-axis direction. In other words, the outer surface of the main body portion 710 includes the pair of curved portions 711 and the pair of flat portions 712. Each of the pair of flat portions 712 is located between the pair of curved portions 711 in the Z-axis direction and has an overall flat shape. The pair of curved portions 711 can also be considered to be disposed at positions sandwiching the flat portions 712 in the Z-axis direction.

The curved portion 711 is a portion that extends in the X-axis direction and protrudes in the Z-axis direction. When viewed from the X-axis direction, the curved portion 711 is curved in a semicircular arc shape (curved shape). The curved portion 711 positioned in the positive direction of the Z-axis directly faces the first curved wall portion 141 of the case main body 160 in the Z-axis direction, and the curved portion 711 positioned in the negative direction of the Z-axis directly faces the second curved wall portion 151 of the case main body 160 in the Z-axis direction. That is, the curved portion 711 and the curved wall portion 141 face each other in the Z-axis direction, and the curved portion 711 and the curved wall portion 151 face each other in the Z-axis direction.

The flat portion 712 is a flat-shaped portion that extends in the X-axis direction and is parallel to an XZ plane that connects end portions of the pair of curved portions 711. The flat portion 712 is a surface perpendicular to the Y-axis direction. The flat portion 712 is disposed to face the respective flat wall portion 131 of the case main body 160. In a portion of the electrode assembly 700 sandwiched between the flat portions 712, a plurality of wound electrode plates (positive electrode plate 740 and negative electrode plate 750) are stacked in the Y-axis direction. In the present description, a main stacking direction of the plurality of electrode plates is defined as the Y-axis direction.

A curved shape of the curved portion 711 as viewed from the X-axis direction is not limited to a semicircular arc shape, and may be a shape such as a part of an elliptical shape or a shape in which corners of a quadrangular shape are rounded. An outer surface of the flat portion 712 is not limited to being completely flat, and the outer surface may be slightly recessed or slightly bulged.

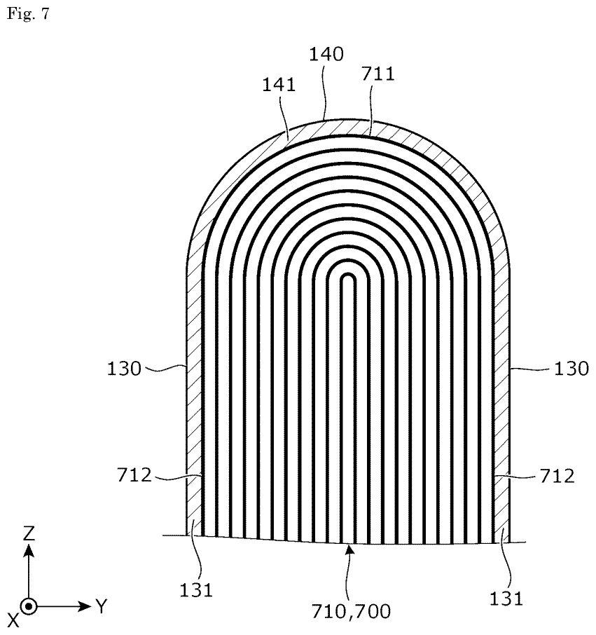

FIG. 7 is a cross-sectional view illustrating a positional relationship between the case 100 and the electrode assembly 700 according to the present example embodiment. FIG. 7 illustrates a state in which an outer surface of the main body portion 710 is entirely in contact with an inner surface of the case 100. Immediately after manufacture of the energy storage device 10, a part of the outer surface of the main body portion 710 of the electrode assembly 700 may not be in contact with the inner surface of the case 100. However, as charge-discharge cycles are repeated, the main body portion 710 of the electrode assembly 700 expands, and the outer surface of the main body portion 710 comes to be entirely in contact with the inner surface of the case 100.

Specifically, inner surfaces of the respective flat wall portions 131 of the case 100 have a flat shape along flat portions 712 of a main body portion 710 of an electrode assembly 700 that face the flat wall portions 131, and each flat portion 712 of the main body portion 710 is in contact with the corresponding inner surface of the respective flat wall portion 131. In FIG. 7, the directly facing flat portions 712 of the main body portion 710 and the inner surfaces of the flat wall portions 131 are entirely in contact with each other; however, there may be portions that are not in contact between the flat portions 712 of the main body portion 710 and the inner surfaces of the flat wall portions 131 due to deformation of a part of the flat portions 712 of the main body portion 710.

An inner surface of the first curved wall portion 141 of the case 100 has a curved shape along the curved portion 711 of the main body portion 710 of the electrode assembly 700, and the curved portion 711 of the main body portion 710 is in contact with the inner surface of the first curved wall portion 141. In FIG. 7, the directly facing curved portion 711 of the main body portion 710 and the inner surface of the first curved wall portion 141 are entirely in contact with each other; however, there may be portions that are not in contact between the curved portion 711 of the main body portion 710 and the inner surface of the first curved wall portion 141 due to deformation of a part of the curved portion 711 of the main body portion 710. Since the second curved wall portion 151 of the case 100 also has the same configuration as described above, illustration and description thereof are omitted.

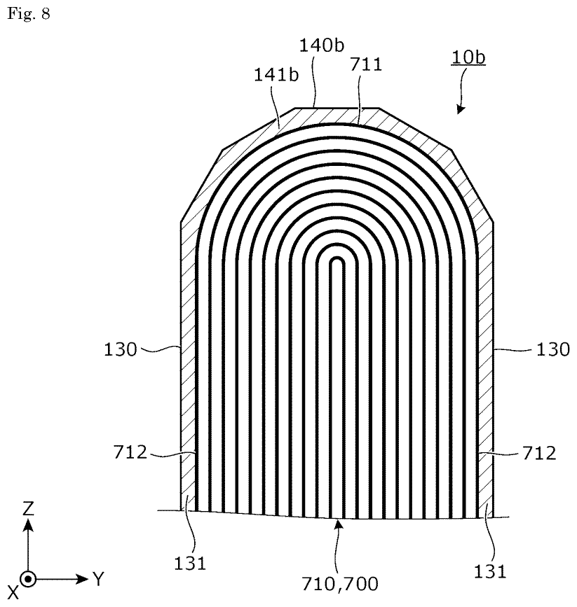

In the present example embodiment, outer surfaces of the curved wall portions 141 and 151 are curved along curved shapes of inner surfaces of the curved wall portions 141 and 151; however, the outer surfaces of the curved wall portions 141 and 151 do not necessarily have to be curved. At least a part of the outer surfaces of the curved wall portions 141 and 151 may have a curved shape having a curvature different from that of the inner surfaces of the curved wall portions 141 and 151 and/or may have a shape including one or more corners. FIG. 8 is a cross-sectional view illustrating a positional relationship between a case 100b and the electrode assembly 700 of an energy storage device 10b according to Modification Example 1. The energy storage device 10b has a configuration similar to that of FIG. 7 in that an outer surface of the main body portion 710 of the electrode assembly 700 is entirely in contact with an inner surface of the case 100b. The energy storage device 10b differs from the energy storage device 10 according to the present example embodiment in that an outer surface of a curved wall portion 141b of the case 100b has a polygonal shape having a plurality of corners when viewed from a winding axis direction.

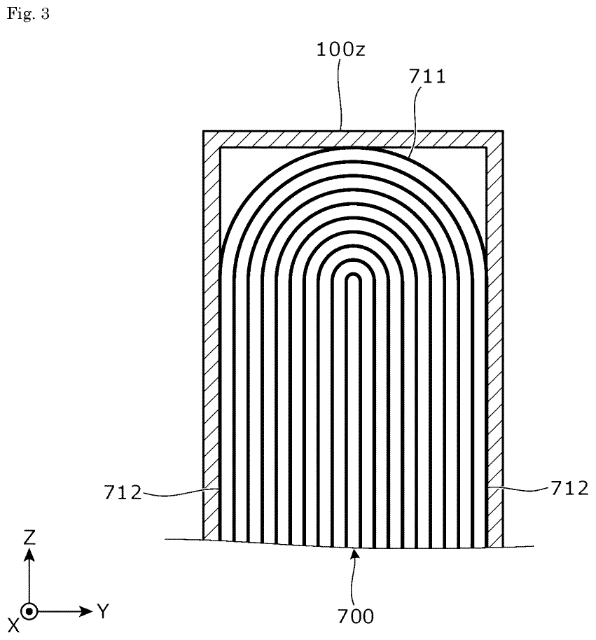

In the energy storage device 10 of the present example embodiment, inner surfaces of the flat wall portions 131 of the case 100 are in contact with the flat portions 712 of the electrode assembly 700, and inner surfaces of the curved wall portions 141 and 151 are in contact with the curved portions 711 of the electrode assembly 700. Accordingly, an extra space inside the case 100 of the energy storage device 10 can be made smaller than that in a prismatic case (see FIG. 3), and a reduction in the volumetric energy density inside the case 100 of the energy storage device 10 can be reduced or prevented. Since the energy storage device 10b of Modification Example 1 has the same configuration, an extra space inside the case 100b of the energy storage device 10b can also be made smaller than that in a prismatic case (see FIG. 3), and a reduction in volumetric energy density inside the case 100b of the energy storage device 10b can be reduced or prevented.

Beginning of Life (BOL) of the energy storage device 10 includes a time at shipment or immediately after manufacture. Immediately after the manufacture, a case in which a number of charge-discharge cycles after an initial charging of the energy storage device 10 is smaller than a predetermined number is also assumed. The predetermined number is a number of charge-discharge cycles at which the main body portion 710 of the electrode assembly 700 expands such that the outer surface of the main body portion 710 can entirely come into contact with the inner surface of the case 100. The predetermined number is preferably 10, more preferably 5, and further preferably 3. Even when the number of charge-discharge cycles of the energy storage device 10 is smaller than the predetermined number, the configuration is included in the present invention as long as, during use of the energy storage device 10, the main body portion 710 of the electrode assembly 700 expands and the outer surface of the main body portion 710 entirely comes into contact with the inner surface of the case 100.

As described above, according to the energy storage device 10 according to the present example embodiment of the present invention, since the inner surfaces of the curved wall portions 141 and 151 of the case 100 have curved shapes along the curved portions 711 of the electrode assembly 700 and face the curved portions 711, and the inner surfaces of the flat wall portions 131 of the case 100 have flat shapes along the flat portions 712 of the electrode assembly 700 and face the flat portions 712, extra space inside the case 100 of the energy storage device 10 can be made smaller than that in a prismatic case, and a reduction in the volumetric energy density inside the case 100 of the energy storage device 10 can be reduced or prevented.

With the above configuration, since extra space generated between the outer surface of the electrode assembly 700 and the inner surface of the case 100 of the energy storage device 10 is reduced overall, heat generated in the electrode assembly 700 can be more easily released to the outside than in the case of a prismatic case in which extra space (a gap) is generated because the outer surface of the curved portion of the electrode assembly does not follow the inner surface of the case. As a result, cooling performance of the energy storage device 10 is improved. Further, since the extra space generated between the outer surface of the electrode assembly 700 and the inner surface of the case 100 of the energy storage device 10 is small overall, when detecting contamination such as metal fragments in the extra space using an apparatus, a detection depth (thickness) can be reduced. Accordingly, contamination detection by the apparatus becomes easier.

Since the pair of terminals 300 protrudes from the outer surface of the first curved wall portion 141 of the case 100, the pair of terminals 300 is positioned at an end portion of the energy storage device 10 in a direction approaching from the second curved wall portion 151 toward the first curved wall portion 141. Accordingly, even after a plurality of energy storage devices 10 are unitized, approach to the terminals 300 from outward is facilitated. Accordingly, electrical connection (such as welding) between the terminals 300 and bus bars or the like is facilitated.

It is known that, in a wound electrode assembly using an electrode plate in which a positive active material of the wound electrode assembly 700 includes a lithium transition metal composite oxide having an α-NaFeO₂ type crystal structure and including a nickel element, and in which a content of the nickel element with respect to transition metal elements included in the lithium transition metal composite oxide is about 50 mol % or more, the volumetric energy density of the positive active material is increased, while expansion of a curved portion of the electrode assembly due to charge-discharge becomes significant. In an energy storage device in which a flat-shaped wound electrode assembly including such a positive active material is accommodated in a prismatic case, extra space between a curved portion of the electrode assembly and an inner surface of the case is relatively large, and expansion of the curved portion of the electrode assembly tends to progress more significantly. In contrast, in the energy storage device 10 according to the present example embodiment, such a flat-shaped wound electrode assembly 700 including the above-described positive active material is accommodated in the case 100 having an inner surface with a curved shape along an outer surface of the curved portions 711, whereby extra space inside the case 100 can be made smaller than that in a prismatic case, and expansion of the electrode assembly at the curved portions can be reduced or prevented even when a positive active material having high volumetric energy density is used. As described above, the effect of improving the volumetric energy density inside the case 100 of the energy storage device 10 is remarkably exhibited.

The effects of the energy storage device 10 according to the above-described example embodiments are effects that can be similarly obtained in the energy storage device 10b of Modification Example 1.

Hereinafter, modification examples (Modification Examples 2 to 9) of the above-described example embodiments will be described. In the following description, the same reference numerals may be assigned to portions that are the same as those of the above-described example embodiments or other modification examples, and description thereof may be omitted.

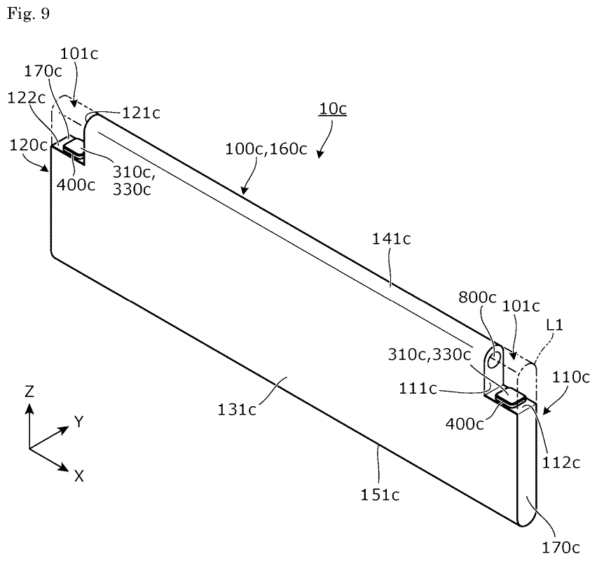

An energy storage device 10c according to Modification Example 2 will be described. FIG. 9 is a perspective view illustrating an appearance of the energy storage device 10c according to Modification Example 2, and an elongated oblong cylindrical region serving as a reference for an outer shape of a case 100c is illustrated by a two-dot chain line L1.

As illustrated in FIG. 9, the case 100c of the energy storage device 10c includes a lid body 170c that covers an end portion in the positive direction of the X-axis and the lid body 170c that covers an end portion in the negative direction of the X-axis. The energy storage device 10c differs from the energy storage device 10 according to the example embodiments in that each lid body 170c of the case 100c has a bent shape. Specifically, in the lid body 170c, a region from a central portion in the Z-axis direction to an end portion in the negative direction of the Z-axis has a bent shape protruding in the X-axis direction. Further, at an end portion in the X-axis direction, a region from a central portion in the Z-axis direction of a flat wall portion 131c to a curved wall portion 151 protrudes in the X-axis direction relative to other portions of the flat wall portion 131c and the curved wall portion 141. Positive electrode members are disposed on a first side surface portion 110c constituting an outer surface of the lid body 170c in the positive direction of the X-axis. Negative electrode members are disposed on a second side surface portion 120c constituting an outer surface of the lid body 170c in the negative direction of the X-axis. Examples of the positive electrode members include a terminal 300c, an external gasket 400c, an internal gasket 500c, a current collector 600c, and the like and examples of the negative electrode members include the terminal 300c, the external gasket 400c, the internal gasket 500c, the current collector 600 c, and the like. In Modification Example 2, the first side surface portion 110c and the second side surface portion 120c are positioned, in the X-axis direction, within a range of 1% to 10% of a length of the case 100c from end surfaces of the case 100c in the X-axis direction; however, the range of the length of the case 100c in the X-axis direction may be greater than 10%.

The energy storage device 10c includes one notch at each of an end portion in the positive direction of the X-axis and an end portion in the negative direction of the X-axis at an end portion of the case 100c in the positive direction of the Z-axis. That is, the energy storage device 10c includes a pair of notches (a pair of first notches). In other words, the case 100c includes, at an end portion in the positive direction of the Z-axis, a pair of notches (a pair of first notches) positioned with respect to each other in a winding axis direction of the electrode assembly 700.

The pair of first notches are disposed at positions sandwiching the first curved wall portion 141c in the X-axis direction (winding axis direction). Each notch is a portion in which a corner (end portion) of the case 100c is cut out, and when viewed from the Y-axis direction, each notch is cut out in a rectangular shape. In other words, an outer shape of the case 100c has a shape in which rectangular notches, when viewed from the Y-axis direction, are formed at both end portions in the X-axis direction and at an upper portion (an end portion in the positive direction of the Z-axis), with respect to a long oblong cylindrical shape that is long in the X-axis direction and flat in the Y-axis direction. Each notch can also be considered to form a recessed portion obtained by recessing a part of the reference long oblong cylindrical shape. Among the plurality of notches, each of the pair of notches positioned at an upper portion of the case 100c (the pair of first notches) is a first recessed portion 101c. Each notch may have any cut-out shape. At least a part of each notch may have a curved shape, may have one or more corner portions, or may not penetrate in the Y-axis direction. Shapes of notches of energy storage devices to be described later are also not particularly limited.

The first side surface portion 110c includes a first upper side surface 111c and a first upper surface 112c. The first upper side surface 111c is a surface parallel to the YZ plane and facing the positive direction of the X-axis. The first upper surface 112c is a surface parallel to the XY plane and facing the positive direction of the Z-axis. The first upper side surface 111c is continuous with the first upper surface 112c and is a surface positioned at a most positive direction of the Z-axis among outer surfaces of the lid body 170c positioned in the positive direction of the X-axis. The first upper surface 112c is a surface continuous with the first upper side surface 111c and a surface of the lid body 170c positioned in the negative direction of the Z-axis relative to the first upper surface 112c.

The second side surface portion 120c includes a second upper side surface 121c and a second upper surface 122c. Since a configuration of outer surfaces of the lid body 170c in the negative direction of the X-axis is the same as a configuration of outer surfaces of the lid body 170c in the positive direction of the X-axis, description thereof is omitted.

One terminal 300c is disposed on the first upper surface 112c of the first side surface portion 110c, and one terminal 300c is disposed on the second upper surface 122c of the second side surface portion 120c.

A gas release valve 800c is disposed at an end portion of the lid body 170c in the positive direction of the Z-axis. The gas release valve 800c is disposed on the lid body 170c that covers an end portion in the positive direction of the X-axis and/or on the lid body 170c that covers an end portion in the negative direction of the X-axis.

The terminal installation surface is a surface that forms the respective first recessed portion 101c and faces the positive direction of the Z-axis. Specifically, the terminal installation surface positioned on an outer surface of the lid body 170c in the positive direction of the X-axis is the first upper surface 112c, and the terminal installation surface positioned on an outer surface of the lid body 170c in the negative direction of the X-axis is the second upper surface 122c. The first upper surface 112c and the second upper surface 122c are outer surfaces of wall portions constituting the case 100c, in which a direction approaching from the second curved wall portion 151c toward the first curved wall portion 141c is a direction penetrating from an inner surface of the case 100c to an outer surface of the case 100c. In this manner, in the present example embodiment, one terminal 300c and one external gasket 400c are disposed on a surface of the lid body 170c in the positive direction of the X-axis and on a surface of the lid body 170c in the negative direction of the X-axis. It can also be considered that the pair of terminals 300c and the pair of external gaskets 400c are disposed on a plurality of wall portions (two wall portions) of the case 100c.

In the energy storage device 10c according to Modification Example 2, a terminal main body portion 330c protrudes outward from the case 100c in the positive direction of the Z-axis from the terminal installation surface, and protrudes in a direction approaching from the second curved wall portion 151c toward the first curved wall portion 141c of the case 100c. Further, in the energy storage device 10c, the pair of terminals 300c are disposed inside the pair of notches. The terminal main body portion 330c is positioned inside a space S1 formed by the notch and does not protrude outward beyond the space S1. In each lid body 170c, a through hole through which a shaft portion 340c penetrates is formed in a wall portion including the terminal installation surface (in the present example embodiment, the first upper surface 112c and the second upper surface 122c). Each lid body 170c may be bent to match a shape of an end portion of the case main body 160c in the X-axis direction during or after connection between the terminal 300c and the current collector 600c.

Since the pair of terminals 300c are disposed on surfaces in which a direction approaching from the second curved wall portion 151c toward the first curved wall portion 141c is a direction penetrating from an inner surface of the case 100c to an outer surface of the case 100c, and are further provided to protrude in the direction approaching from the second curved wall portion 151c toward the first curved wall portion 141c, an amount of protrusion of the terminals 300c in a direction in which the pair of curved portions 711 face each other can be reduced or prevented. That is, by disposing the terminals 300c inside the notches, a volume of the energy storage device 10c is reduced, and the volumetric energy density becomes higher than in a case where the terminals 300c are disposed on the curved wall portion 141c.

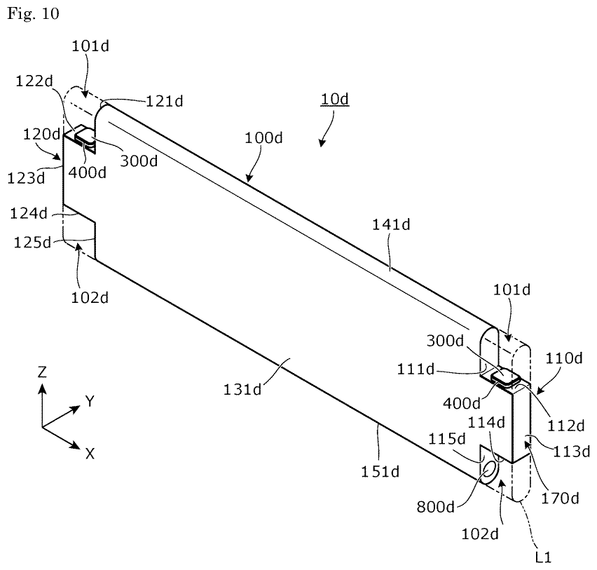

An energy storage device 10d according to Modification Example 3 will be described. FIG. 10 is a perspective view illustrating an appearance of the energy storage device 10d according to Modification Example 3. An oval columnar region serving as a reference of the outer shape of a case 100d is indicated by the two-dot chain line L1. As illustrated in FIG. 10, the case 100d of the energy storage device 10d includes one notch at each of an end portion in the positive direction of the X-axis and an end portion in the negative direction of the X-axis at an end portion of the case 100d in the positive direction of the Z-axis. That is, the energy storage device 10d includes a pair of first notches that is a pair of notches. Furthermore, the case 100d of the energy storage device 10d includes one notch at each of an end portion in the negative direction of the X-axis and an end portion in the positive direction of the X-axis at an end portion of the case 100d in the negative direction of the Z-axis. That is, the energy storage device 10d includes a pair of second notches that is a pair of notches. In other words, the case 100d includes, at an end portion in the positive direction of the Z-axis, a pair of notches (a pair of first notches) positioned with respect to each other in a winding axis direction of the electrode assembly 700, and also includes, at an end portion in the negative direction of the Z-axis, a pair of notches (a pair of second notches) positioned with respect to each other in the winding axis direction of the electrode assembly 700.

Among the plurality of notches, each of the pair of notches positioned at an upper portion of the case 100d (the pair of first notches) is a first recessed portion 101d. The first recessed portions 101d are respective notches constituting the pair of notches positioned at the upper portion of the case 100d among the plurality of notches. The pair of first notches are disposed at positions sandwiching a first curved wall portion 141d in the X-axis direction (winding axis direction). An external gasket 400d and a terminal 300d are installed in each first recessed portion 101d.

Among the plurality of notches, each of a pair of notches positioned at a lower portion of the case 100d (a pair of second notches) is a second recessed portion 102d. The second recessed portions 102d are respective notches constituting the pair of notches positioned at the lower portion of the case 100d among the plurality of notches. The pair of second notches are disposed at positions sandwiching a second curved wall portion 151d in the X-axis direction (winding axis direction). Each notch of the pair of second notches has the same configuration as each notch of the pair of first notches. In other words, the case 100d includes, at an end portion in the positive direction of the Z-axis, a pair of notches (a pair of first notches) positioned with respect to each other in a winding axis direction of the electrode assembly 700, and also includes, at an end portion in the negative direction of the Z-axis, a pair of notches (a pair of second notches) positioned with respect to each other in the winding axis direction of the electrode assembly 700. Accordingly, an outer shape of the case 100d has a shape in which rectangular notches, when viewed from the Y-axis direction, are formed at upper portions and lower portions of both end portions in the X-axis direction, with respect to a long oblong cylindrical shape that is long in the X-axis direction and flat in the Y-axis direction. Each notch can also be considered to form a recessed portion obtained by recessing a part of the reference long oblong cylindrical shape.

The case 100d includes the pair of lid bodies 170d. The lid body 170d in the positive direction of the X-axis is bent to correspond to positions of end portions in the X-axis direction of the curved wall portions 141d and 151d and positions of end portions in the X-axis direction of a flat wall portions 131d. A first side surface portion 110d, which is an outer surface of the lid body 170d in the positive direction of the X-axis, includes a first upper side surface 111d, a first upper surface 112d, a first middle side surface 113d, a first lower surface 114d, and a first lower side surface 115d. The first upper surface 112d and the first lower surface 114d are surfaces parallel to the XY plane. The first upper surface 112d faces the positive direction of the Z-axis, and the first lower surface 114d faces the negative direction of the Z-axis. The first upper side surface 111d, the first middle side surface 113d, and the first lower side surface 115d are surfaces parallel to the YZ plane and can also be said to face the positive direction of the X-axis. The first upper side surface 111d is continuous with the first upper surface 112d and is a surface positioned at a most positive direction of the Z-axis among outer surfaces of the lid body 170d positioned in the positive direction of the X-axis. The first lower side surface 115d is continuous with the first lower surface 114d and is a surface positioned at a most negative direction of the Z-axis among outer surfaces of the lid body 170d positioned in the positive direction of the X-axis. The first middle side surface 113d is a surface continuous with the first upper surface 112d and the first lower surface 114d, and is disposed at a position sandwiched between the first upper side surface 111d and the first lower side surface 115d in the Z-axis direction when viewed from the X-axis direction. Of the pair of lid bodies 170, the lid body 170 in the negative direction of the X-axis is bent, similarly to the lid body 170 in the positive direction of the X-axis, to correspond to positions of end portions in the X-axis direction of the curved wall portions 141d and 151d and positions of end portions in the X-axis direction of the flat wall portions 131d. A second side surface portion 120d, which is an outer surface of the lid body 170d in the negative direction of the X-axis, includes a second upper side surface 121d, a second upper surface 122d, a second middle side surface 123d, a second lower surface 124d, and a second lower side surface 125d. Since a configuration of outer surfaces of the lid body 170d in the negative direction of the X-axis is the same as a configuration of outer surfaces of the lid body 170d positioned in the positive direction of the X-axis, description thereof is omitted.

As shown in FIG. 10, in the case 100d of the energy storage device 10d, the gas release valve 800d is disposed on a plane parallel to the YZ plane in each of the second recessed portions 102d. Specifically, the gas release valves 800d are disposed on the first lower surface 114d and the second lower surface 124d of outer surfaces of the pair of lid bodies 170d. Note that the gas release valve 800d may be provided in the first recessed portion 101d. Further, the gas release valve 800d may be provided in only one second recessed portions 102d. Other configurations of the energy storage device 10d are the same as those of the energy storage device 10c according to Modification Example 2.

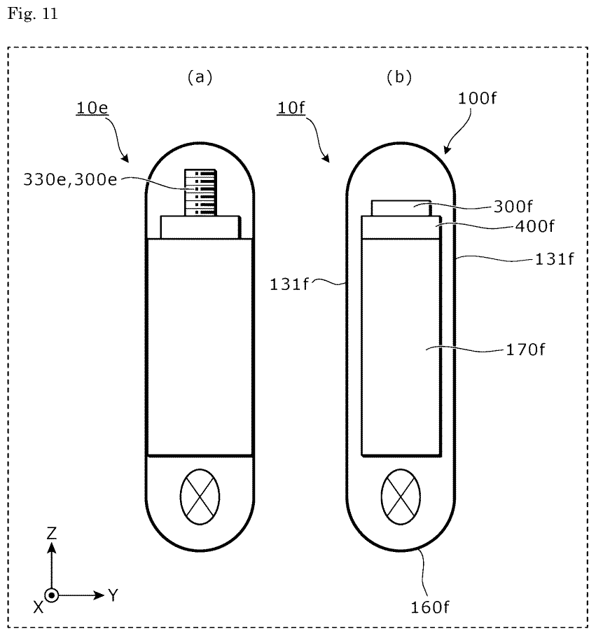

An energy storage device 10e according to Modification Example 4 and an energy storage device 10 f according to Modification Example 5 will be described. FIG. 11(a) is a plan view illustrating an appearance of the energy storage device 10e according to Modification Example 4 when viewed from the positive direction of the X-axis, and FIG. 11(b) is a plan view illustrating an appearance of the energy storage device 10f according to Modification Example 5 when viewed from the positive direction of the X-axis.

As illustrated in FIG. 11(a), in the energy storage device 10e, a terminal main body portion 330e of a terminal 300e is constituted by a bolt. Although not illustrated, the same is also applied to the terminal 300e in the negative direction of the X-axis. Other configurations are the same as those of the energy storage device 10 d according to Modification Example 3 illustrated in FIG. 10, and therefore description thereof is omitted.

In the energy storage device 10f, as illustrated in FIG. 11(b), end portions in the positive direction of the X-axis of the respective flat wall portions 131f of the case 100f are disposed further inward in the Y-axis direction than respective flat wall portions 131f in a central region in the X-axis direction. Here, the end portions in the positive direction of the X-axis refer to regions of the flat wall portions 131f that face the plurality of tab portions 720 of the electrode assembly 700 in the Y-axis direction. The central region in the X-axis direction refers to a region of the flat wall portions 131f that faces the main body portion 710 of the electrode assembly 700 in the Y-axis direction. That is, in the flat wall portion 131f positioned in the positive direction of the Y-axis, the position in the Y-axis direction at the end portion in the positive direction of the X-axis is shifted toward the negative direction of the Y-axis relative to the position in the Y-axis direction of the flat wall portion 131f in a region facing the outer surface of the main body portion 710 in the positive direction of the Y-axis. In the flat wall portion 131f positioned in the negative direction of the Y-axis, the position in the Y-axis direction at the end portion in the positive direction of the X-axis is shifted toward the positive direction of the Y-axis relative to the position in the Y-axis direction of the flat wall portion 131f in a region facing the outer surface of the main body portion 710 in the negative direction of the Y-axis. Although not illustrated, the same is also applied to the configuration of the flat wall portions 131f at the end portions in the negative direction of the X-axis. Other configurations are the same as those of the energy storage device 10d according to Modification Example 3. With the above configuration, in the energy storage device 10f, a gap is formed in the Y-axis direction between adjacent members (the energy storage device 10f and a case 2, or the like) at the end portions in the X-axis direction, and this gap can be used for heat dissipation from the energy storage device 10f and for wiring, or the like.

The energy storage device 10f may be manufactured by the following manufacturing method. First, by extrusion forming, or by rolling a sheet metal and welding end portions in the Z-axis direction to each other, a case main body 160f having aligned end portions in the X-axis direction is formed. Next, the electrode assembly 700 is inserted into the case main body 160f. After the insertion, the current collectors 600 are connected to the respective tab portions 720. Then, an external gasket 400f, the internal gasket 500, a lid body 170f, and a terminal 300f are assembled to each current collector 600, and thereafter each lid body 170f is welded to close the end portions of the case main body 160f from the X-axis direction. Thereafter, an electrolyte solution is injected into the case 100f through an electrolyte solution filling portion, and the electrolyte solution filling portion is sealed. The manufacturing method of an energy storage device 10i according to Modification Example 8 described later is also the same.

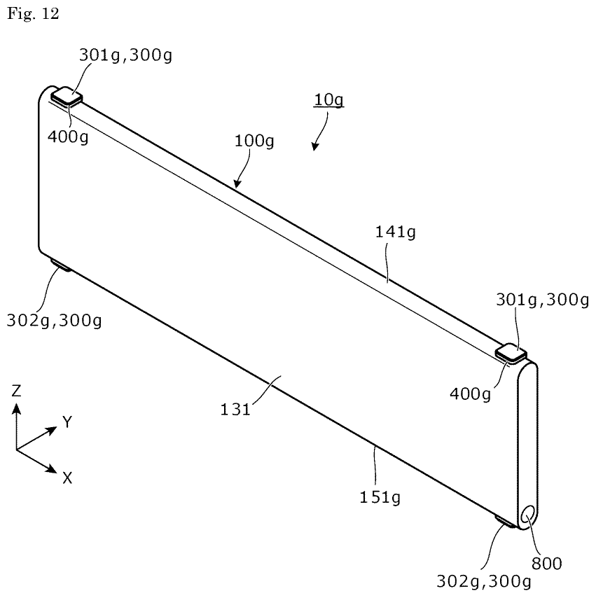

An energy storage device 10g according to Modification Example 6 will be described. FIG. 12 is a perspective view illustrating an appearance of the energy storage device 10g according to Modification Example 6. The energy storage device 10g has a configuration in which terminals 300g and external gaskets 400g are disposed at each end portion in the X-axis direction of the first curved wall portion 141 and at each end portion in the X-axis direction of the second curved wall portion 151 of the energy storage device 10 (FIG. 4) according to the present example embodiment. That is, the energy storage device 10g includes four terminals 300g and four external gaskets 400g. Specifically, first terminals 301g are disposed at an end portion in the positive direction of the X-axis and an end portion in the negative direction of the X-axis of a first curved wall portion 141g, thereby forming the pair of first terminals 301g. Further, second terminals 302g are disposed at an end portion in the positive direction of the X-axis and an end portion in the negative direction of the X-axis of the second curved wall portion 151g, thereby forming a pair of second terminals 302g. Here, the first curved wall portion 141g is one wall portion of the case 100g in which a direction approaching from the second curved wall portion 151g to the first curved wall portion 141g is a direction penetrating from an inner surface to an outer surface of the case 100g. The second curved wall portion 151g is one wall portion of the case 100g in which a direction approaching the second curved wall portion 151g from the first curved wall portion 141g is a direction penetrating from the inner surface to the outer surface of the case 100g.

Although not illustrated, in the electrode assembly of the energy storage device 10g according to Modification Example 6, two tab portions protrude from each end surface of the main body portion in the X-axis direction. The electrode assembly may have a configuration in which two positive electrode tab portions are provided on the end surface (one end surface) of the main body portion in the positive direction of the X-axis, and two negative electrode tab portions are provided on the end surface (the other end surface) of the main body portion in the negative direction of the X-axis. The electrode assembly may also have a configuration in which one positive electrode tab portion and one negative electrode tab portion are provided on an end surface (one end surface) of the main body portion 710 in the positive direction of the X-axis, and one positive electrode tab portion and one negative electrode tab portion are provided on an end surface (the other end surface) of the main body portion in the negative direction of the X-axis. The arrangement of the positive electrode tab portion and the negative electrode tab portion on an end surface (one end surface) in the positive direction of the X-axis does not need to be the same as the arrangement of the positive electrode tab portion and the negative electrode tab portion on an end surface (the other end surface) in the negative direction of the X-axis. Other configurations of the energy storage device 10g are the same as those of the energy storage device 10 according to the present example embodiment. Also in an energy storage device 10h according to Modification Example 7 and the energy storage device 10i according to Modification Example 8, which will be described later, a configuration is adopted in which two tab portions protrude from each end surface of the main body portion in the X-axis direction; however, a description thereof is omitted.

Since the pair of terminals 300g (the pair of first terminals 301g and the pair of second terminals 302g) protrude from outer surfaces of respective curved wall portions (the first curved wall portion 141g and the second curved wall portion 151g) of the case 100g, volumetric energy density of the energy storage device 10g can be increased as compared with a case where the pair of terminals 300g protrude from respective end portions of the case 100g in a winding axis direction (X-axis direction). Further, since the pair of first terminals 301g are positioned at an end portion of the energy storage device 10g in a direction approaching from the second curved wall portion 151g toward the first curved wall portion 141g, and the pair of second terminals 302g are positioned at an end portion of the energy storage device 10g in a direction approaching from the first curved wall portion 141g toward the second curved wall portion 151g, even after a plurality of energy storage devices 10g are assembled into a unit, outward approach to the terminals 300g is facilitated. Accordingly, electrical connection (such as welding) between the terminals 300g and bus bars or the like is facilitated. Further, since the energy storage device 10g includes two pairs of terminals 300g (the pair of first terminals 301g and the pair of second terminals 302g), a current can be efficiently taken out from the energy storage device 10g. That is, by configuring the energy storage device 10g to have a four-terminal structure, resistance can be reduced, and the energy storage device can exhibit excellent power performance.

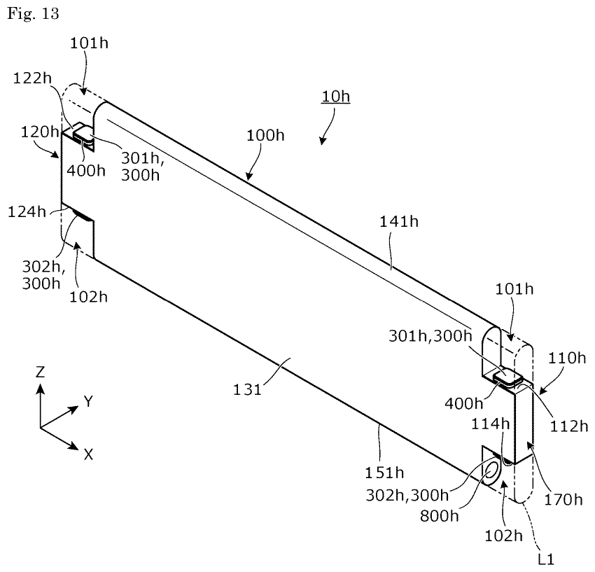

An energy storage device 10h according to Modification Example 7 will be described. FIG. 13 is a perspective view illustrating an appearance of the energy storage device 10h according to Modification Example 7. An oval columnar region serving as a reference of the outer shape of a case 100h of the energy storage device 10h is indicated by the two-dot chain line L1. The energy storage device 10h differs from the energy storage device 10d according to Modification Example 3 (see FIG. 10) in that a second terminal 302h and an external gasket 400h are disposed on a surface parallel to the XY plane (first lower surface 114h or second lower surface 124h) in each second recessed portion 102h. That is, one energy storage device 10h includes four terminals 300h and four external gaskets 400h. Here, a pair of first terminals 301h are disposed within a pair of first notches, and terminal main body portions 330h are positioned inside the space S1 formed by the notches, and do not protrude outward beyond the space S1. Similarly, the pair of second terminals 302h are disposed within a pair of second notches, and the terminal main body portions 330h are positioned inside a space S2 formed by the notches, and do not protrude outward beyond the space S2.

In the energy storage device 10h, terminal installation surfaces are a surface facing the positive direction of the Z-axis that forms each first recessed portion 101h, and a surface facing the negative direction of the Z-axis that forms each second recessed portion 101h. More specifically, the terminal installation surfaces positioned on outer surfaces of lid bodies 170h positioned in the positive direction of the X-axis are a first upper surface 112h and the first lower surface 114h, and the terminal installation surfaces positioned on outer surfaces of the lid bodies 170h in the negative direction of the X-axis are a second upper surface 122h and the second lower surface 124h. Here, the first upper surface 112h and the second upper surface 122h, on which the pair of first terminals 301h are disposed, can be regarded as outer surfaces of two wall portions among wall portions constituting the case 100h, in which a direction approaching from a second curved wall portion 151h toward a first curved wall portion 141h is a direction penetrating from an inner surface to an outer surface of the case 100h. The first lower surface 114h and the second lower surface 124h of the lid body 170h, on which the pair of second terminals 302h are disposed, can be regarded as outer surfaces of two wall portions among wall portions constituting the case 100h, in which a direction approaching from the first curved wall portion 141h toward the second curved wall portion 151h is a direction penetrating from an inner surface to an outer surface of the case 100h. A gas release valve 800h is disposed on a surface parallel to the YZ plane that forms the second recessed portion 102h; however, it may alternatively be disposed on a surface parallel to the YZ plane that forms the first recessed portion 101h. Other configurations of the energy storage device 10h are the same as those of the energy storage device 10d according to Modification Example 3. Thus, in the energy storage device 10h according to Modification Example 7, two terminals 300h are disposed on each of surfaces of the lid body 170h in the positive direction of the X-axis and the lid body 170h in the negative direction of the X-axis, and the pair of first terminals 301h and the pair of second terminals 302h are disposed on wall portions of the case 100h.

Since the pair of first terminals 301h are provided to protrude, within the pair of first recessed portions 101h, in a direction approaching from the second curved wall portion 151h toward the first curved wall portion 141h, an amount of outward protrusion of the pair of first terminals 301h of the case 100h in the direction approaching from the second curved wall portion 151h toward the first curved wall portion 141h can be reduced or prevented. Similarly, since the pair of second terminals 302h are provided to protrude, within the pair of second recessed portions 102h, in a direction approaching from the first curved wall portion 141h toward the second curved wall portion 151h, an amount of outward protrusion of the pair of second terminals 302h of the case 100h in the direction approaching from the first curved wall portion 141h toward the second curved wall portion 151h can be reduced or prevented. As described above, since the energy storage device 10h includes two pairs of terminals 300h (a pair of first terminals and a pair of second terminals), a current can be efficiently taken out from the energy storage device 10h. Further, by disposing the terminals 300h within the notches (the pair of first notches and the pair of second notches), the volume of the energy storage device 10h can be reduced, and the volumetric energy density of the energy storage device 10h can be increased as compared with a case where the terminals 300h are disposed on the curved wall portions 141h and 151h.

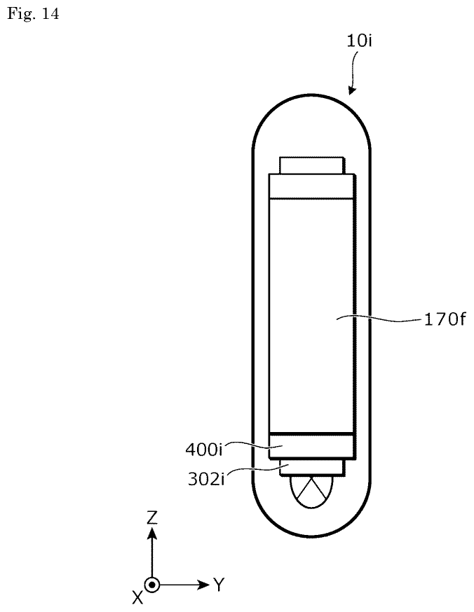

The energy storage device 10i according to Modification Example 8 will be described. FIG. 14 is a plan view illustrating an appearance of the energy storage device 10i according to Modification Example 8 when viewed from the positive direction of the X-axis.

The energy storage device 10i differs from the energy storage device 10f according to Modification Example 5 in that a pair of external gaskets 400i and a pair of second terminals 302i are disposed; however, otherwise has the same configuration as the energy storage device 10f according to Modification Example 5. With this configuration, in the energy storage device 10i, a gap is formed in the Y-axis direction between adjacent members (the energy storage device 10i and the case 2, or the like) at the end portions in the X-axis direction, and this gap can be used for heat dissipation from the energy storage device 10i and for wiring, or the like.

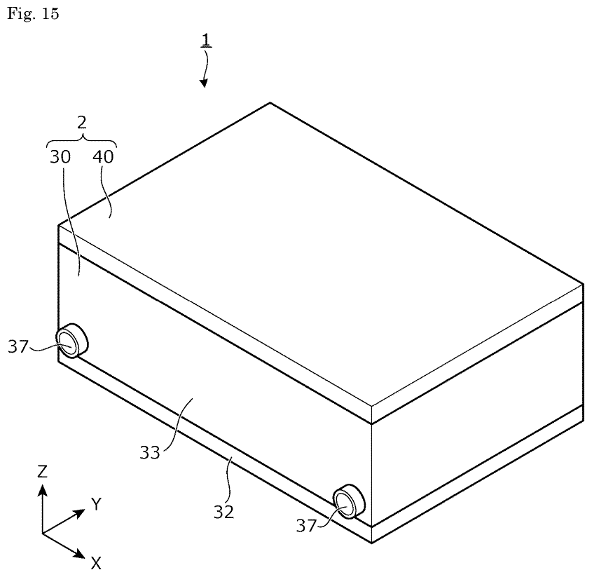

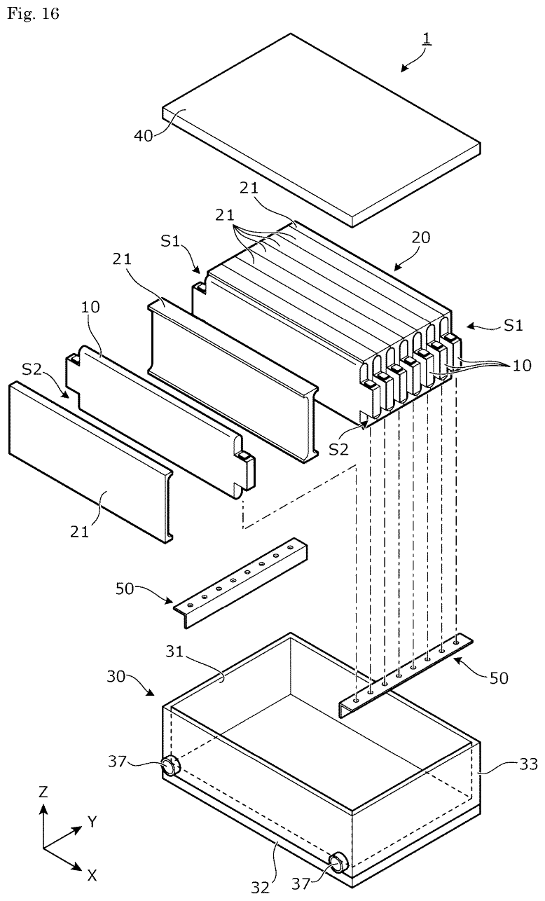

A schematic configuration of an energy storage apparatus 1 in the present example embodiment will be described. FIG. 15 is a perspective view illustrating an appearance of the energy storage apparatus 1 according to the present example embodiment. FIG. 16 is an exploded perspective view illustrating respective elements when the energy storage apparatus 1 according to the present example embodiment is in an exploded manner.

The energy storage apparatus 1 is an apparatus capable of being charged with electricity from outside or discharging electricity to the outside, and in the present example embodiment has a substantially rectangular parallelepiped shape. Here, the term “rectangular parallelepiped” refers to a hexahedron in which all faces are formed of rectangles or squares. The energy storage apparatus 1 is an energy storage device module (assembled battery) used for power storage applications, power supply applications, or the like. Specifically, the energy storage apparatus 1 is used as a battery for driving or engine starting of mobile bodies such as automobiles, motorcycles, watercraft, ships, snowmobiles, agricultural machines, construction machines, automatic guided vehicles (AGVs), or railway vehicles for electric railways. Examples of the automobiles include electric vehicles (EVs), hybrid electric vehicles (HEVs), plug-in hybrid electric vehicles (PHEVs), and vehicles using fossil fuels (gasoline, light oil, liquefied natural gas, or the like). Examples of the railway vehicles for electric railways include electric trains, monorails, linear motor cars, and hybrid trains including both a diesel engine and an electric motor. The energy storage apparatus 1 can also be used as a stationary battery for household use, business use, or the like.

As illustrated in FIG. 15 and FIG. 16, the energy storage apparatus 1 includes the case 2. Inside the case 2, the plurality of energy storage devices 10, a holding unit 20, a pair of exhaust members 50, a plurality of bus bars (not illustrated), and the like are accommodated. The energy storage apparatus 1 also includes external terminals (a positive electrode external terminal and a negative electrode external terminal) for electrical connection to an external apparatus; however, illustration and description thereof are omitted. In addition to the above-described elements, the energy storage apparatus 1 may further include restraining members (such as end plates and side plates) that restrain the plurality of energy storage devices 10, a bus bar holder that holds the bus bars, a bus bar cover, a circuit board that monitors or controls charge and discharge states of the energy storage devices 10, and electrical components such as relays, fuses, shunt resistors, and connectors.

The case 2 is a substantially rectangular parallelepiped-shaped (box-shaped) case (module case) that constitutes an outer case (housing, outer shell) of the energy storage apparatus 1. The case 2 is an example of an external member. The case 2 is disposed outward of the plurality of energy storage devices 10 and the holding unit 20, fixes the plurality of energy storage devices 10 and the holding unit 20 at predetermined positions, and protects them from impacts and the like. The case 2 is a metal case formed of a metal member such as aluminum, aluminum alloys, stainless steel, iron, or plated steel sheets. The case 2 may be formed of an insulating member such as a resin material. In a case where the case 2 is formed of a conductive material, an inner surface of the case 2 may be covered with an insulating material in order to ensure insulating properties from the energy storage devices 10.

As illustrated in FIG. 16, the case 2 includes a case main body 30 that constitutes a main body of the case 2, and a case lid body 40 that constitutes a lid body of the case 2. The case main body 30 is a bottomed rectangular tubular housing (enclosure) having an opening 31 formed in the positive direction of the Z-axis, and accommodates the plurality of energy storage devices 10, the holding unit 20, and the like.

Specifically, the case main body 30 includes a bottom wall 32 and a side wall 33. The bottom wall 32 is a flat plate-shaped rectangular portion disposed at an end portion of the case main body 30 in the negative direction of the Z-axis.

The side wall 33 is a rectangular annular wall portion extending in the positive direction of the Z-axis from the outer peripheral edge of the bottom wall 32, and is provided continuously with respect to the entire circumference of the bottom wall 32. The opening 31 is formed inside the side wall 33. The side wall 33 is provided with a pair of exhaust ports 37, and in the present example embodiment, the exhaust ports 37 are disposed in a negative direction of the Z-axis within the side wall 33. Each exhaust port 37 is a portion connecting the inside and the outside of the case 2, and exhausts the gas discharged from each energy storage device 10 to the outside of the case 2.

The case lid body 40 is a flat rectangular member that closes the rectangular opening 31 of the case main body 30. The case main body 30 and the case lid body 40 are joined by welding, welding, screwing, or the like, and the inside of the case 2 is closed (sealed). The case main body 30 and the case lid body 40 may be made of the same material or different materials.

By including the above-described energy storage device 10, the energy storage apparatus 1 can shorten a length of the energy storage apparatus 1 in a winding axis direction (X-axis direction), thereby providing the energy storage apparatus 1 with an increased volumetric energy density.

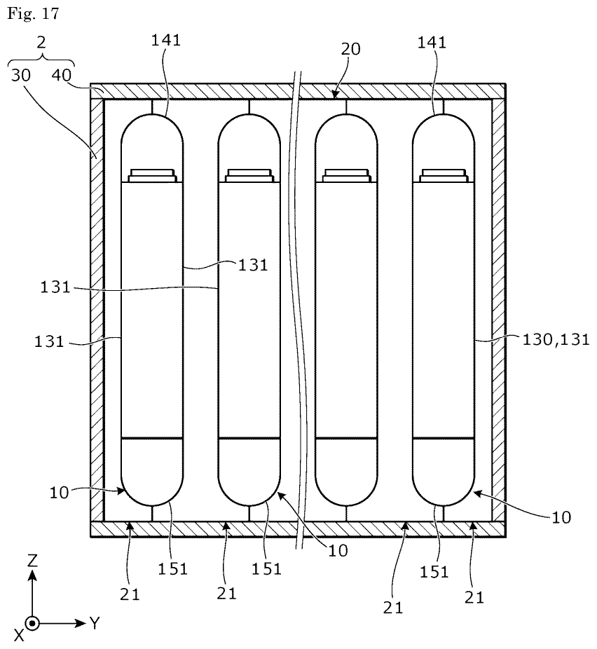

FIG. 17 is an explanatory view illustrating the holding unit 20, the case 2, and the energy storage device 10 according to the present example embodiment. In FIG. 17, only the case 2 is illustrated in a cross-sectional view. As illustrated in FIG. 17, the holding unit 20 includes a plurality of holding members 21 arranged in the Y-axis direction.

The holding members 21 are members which are disposed alternately with the energy storage devices 10 in the Y-axis direction and hold the energy storage devices 10, and perform insulation and/or heat insulation between the energy storage devices 10 and between the energy storage devices 10 and other members. In the present example embodiment, the holding members 21 are disposed to directly face the flat wall portion 131 of the case 100 and at least a part of the curved wall portions 141 and 151 of the case 100, and to overlap a region of an active material layer formation portion of the electrode assembly 700 (see FIG. 6 and FIG. 16). The holding members 21 are insulating plate-shaped members disposed adjacent to the energy storage device 10 in the positive direction of the Y-axis or the negative direction of the Y-axis of the energy storage device 10, and insulate between the energy storage devices 10 or between the energy storage device 10 and the case 2. The holding members 21 may be formed of insulating materials such as PC, PP, PE, PS, ABS resin, or composite materials thereof, or may be formed of metal members whose surfaces are covered with an insulating material.

Although the energy storage devices according to the example embodiments of the present invention (including modification examples thereof; the same applies hereinafter) have been described above, the present invention is not limited to the above example embodiments. The example embodiments disclosed herein are illustrative in all respects, and the scope of the present invention includes all modifications within the meaning and range equivalent to the claims.

The direction approaching from the second curved wall portion toward the first curved wall portion is determined as follows. A point that is positioned at the center in the longitudinal direction (the X direction in FIG. 4) of the second curved wall portion and at the center in the width direction (the Y direction in FIG. 4) of the second curved wall portion is defined as a second curved wall portion center point. A point that is positioned at the center in the longitudinal direction (the X direction in FIG. 4) of the first curved wall portion and at the center in the width direction (the Y direction in FIG. 4) of the first curved wall portion is defined as a first curved wall portion center point. In the energy storage device case, the direction approaching from the second curved wall portion toward the first curved wall portion is defined as a direction from a center point of the second curved wall portion toward a center point of the first curved wall portion. One or more wall portions in which the direction approaching from the second curved wall portion toward the first curved wall portion becomes a direction penetrating from an inner surface of the case to an outer surface thereof mean wall portions in which, in a case where penetration is performed linearly in the direction approaching from the second curved wall portion toward the first curved wall portion, an area where the penetration direction is directed from the inner surface toward the outer surface of the case accounts for a majority. Such penetration does not need to be perpendicular to the wall surface and may be inclined from the perpendicular. Examples of one or more wall portions in which the direction approaching from the second curved wall portion toward the first curved wall portion becomes a direction penetrating from the inner surface to the outer surface of the case include the first curved wall portions 141 and 141d in FIG. 4 and FIG. 12, and wall portions on which the terminals (300c, 300d, and 300h) are disposed in the pair of first recessed portions (101c, 101d, and 101h) in FIG. 9, FIG. 10, and FIG. 13. Among a plurality of curved wall portions present in the wall portions of the case, which curved wall portion is defined as the first curved wall portion and which curved wall portion is defined as the second curved wall portion is optional. In a case where any one of the curved wall portions is defined as a first curved wall portion and a different one of the curved wall portions is defined as a second curved wall portion, it is sufficient that there exists a combination of the first curved wall portion and the second curved wall portion that satisfies “a pair of terminals is disposed on one or more wall portions among wall portions constituting the case, in which a direction approaching from the second curved wall portion toward the first curved wall portion is a direction penetrating from an inner surface of the case to an outer surface thereof, and protrudes in the direction approaching from the second curved wall portion toward the first curved wall portion”. The pair of terminals protruding in a direction approaching from the second curved wall portion toward the first curved wall portion does not require that the protruding direction of the pair of terminals be completely identical to that direction. Even if the both directions are deviated from each other, it is sufficient that the amount of protrusion of the pair of terminals in the direction approaching from the second curved wall portion toward the first curved wall portion is represented as a positive value.

In the example embodiments, a case has been exemplified in which each terminal is disposed at both end portions of the case in the winding axis direction (X-axis direction); however, each terminal may be disposed at a position other than the end portions in the winding axis direction (X-axis direction).

In the example embodiments, a case has been exemplified in which only one electrode assembly 700 is accommodated in the case; however, two or more electrode assemblies arranged in the X-axis direction may be accommodated in the case.

In the example embodiments, a case has been exemplified in which the flat portions 712 of the electrode assembly 700 are entirely flat; however, at least a part of the flat portions 712 of the electrode assembly 700 may have a shape recessed in a direction toward the winding axis center. In such a case, at least a part of the flat wall portions of the case may have a shape bulging to follow the outer surface of the flat portions 712 of the electrode assembly 700.

In the example embodiments, a case has been exemplified in which the curved portions 711 of the opposing electrode assembly 700 and the curved wall portions of the case are in direct contact with each other; however, an insulating sheet or the like may be disposed between the opposing curved portions 711 and the curved wall portions.

In the example embodiments, a case has been exemplified in which a gas release valve is disposed on a lid body; however, the gas release valve may be disposed on a flat wall portion of the energy storage device, or may be disposed on a curved wall portion. The number of gas release valves disposed may be one, two, or three or more.

In the example embodiments, the energy storage apparatus 1 in which the plurality of energy storage devices 10 are accommodated in the case 2 has been exemplified; however, the energy storage apparatus in which one or more energy storage devices are accommodated in a case may also be used.

In the example embodiments, a case where a plurality of energy storage devices 10 are accommodated in a case 2, which is an external member, has been exemplified; however, the external member may merely fix the energy storage devices without accommodating them. In this case, the external member may be a frame body or the like disposed outward of the energy storage devices.

In the above example embodiments, the case where the external member is the box-shaped case 2 has been exemplified. The external member may be formed by aluminum die casting. In addition, the external member may be a member constituting a moving body itself such as an automobile. Examples of the moving body itself include a skeleton structure of the moving body, a carriage, a chassis, and the like.

In the above example embodiments, the case of the packed energy storage apparatus 1 in which the energy storage devices 10 and the holding units 20 are accommodated in the case 2 has been exemplified; however, the energy storage apparatus may be a module type energy storage apparatus.

Example embodiments constructed by arbitrarily combining the components included in the above example embodiments and the modification examples thereof are also included in the scope of the present invention.

Example embodiments of the present invention can be applied to energy storage devices such as lithium ion secondary batteries, and to energy storage apparatuses including the same.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage device comprising:
an electrode assembly in which an electrode plate is wound;
a case accommodating the electrode assembly; and
a pair of terminals provided in the case; wherein
the electrode assembly has a flat shape including a pair of opposing curved portions and a flat portion connecting the pair of curved portions;
the case includes:
a pair of curved wall portions each facing a respective one of the pair of curved portions of the electrode assembly; and
flat wall portions each facing both surfaces of the flat portion of the electrode assembly;
the pair of curved wall portions are a first curved wall portion and a second curved wall portion;
an inner surface of the first curved wall portion and an inner surface of the second curved wall portion each have a curved shape along the curved portions of the electrode assembly;
inner surfaces of the flat wall portions each have a flat shape along the flat portion of the electrode assembly; and
the pair of terminals are provided in one or more of the wall portions of the case, in which a direction approaching from the second curved wall portion toward the first curved wall portion is a direction penetrating from an inner surface to an outer surface of the case; and
the pair of terminals protrude in the direction approaching from the second curved wall portion toward the first curved wall portion.

2. The energy storage device according to claim 1, wherein the pair of terminals protrude from an outer surface of the first curved wall portion in the direction approaching from the second curved wall portion toward the first curved wall portion.

3. The energy storage device according to claim 1, wherein
the case includes a pair of notches positioned relative to each other in a winding axis direction of the electrode assembly;
the pair of notches are located at positions sandwiching the first curved wall portion of the case in the winding axis direction; and
the pair of terminals are located within the pair of notches and on a surface in which the direction approaching from the second curved wall portion toward the first curved wall portion is the direction penetrating from the inner surface of the case to the outer surface of the case; and
the pair of terminals protrude in the direction approaching from the second curved wall portion toward the first curved wall portion.

4. The energy storage device according to claim 1, further comprising:
a pair of first terminals and a pair of second terminals provided in the case; wherein
the pair of first terminals are the pair of terminals;
the pair of first terminals protrude from an outer surface of the first curved wall portion in the direction approaching from the second curved wall portion toward the first curved wall portion; and
the pair of second terminals protrude from an outer surface of the second curved wall portion in a direction approaching from the first curved wall portion toward the second curved wall portion.

5. The energy storage device according to claim 1, further comprising:
a pair of first terminals and a pair of second terminals provided in the case; wherein
the pair of first terminals are the pair of terminals;
the case includes a pair of first notches and a pair of second notches;
the pair of first notches are located at positions sandwiching the first curved wall portion of the case in a winding axis direction of the electrode assembly;
the pair of second notches are located at positions sandwiching the second curved wall portion of the case in the winding axis direction;
the pair of first terminals are located within the pair of first notches and on a surface in which the direction approaching from the second curved wall portion toward the first curved wall portion is the direction penetrating from the inner surface of the case to the outer surface of the case; and
the pair of first terminals protrude in the direction approaching from the second curved wall portion toward the first curved wall portion; and
the pair of second terminals are located within the pair of second notches and on a surface in which a direction approaching from the first curved wall portion toward the second curved wall portion is the direction penetrating from the inner surface of the case to the outer surface of the case; and
the pair of second terminals protrude in the direction approaching from the first curved wall portion toward the second curved wall portion.

6. The energy storage device according to claim 1, wherein
the electrode plate includes a positive active material including a lithium transition metal composite oxide having an α-NaFeO₂ type crystal structure and including a nickel element; and
a content of the nickel element with respect to transition metal elements included in the lithium transition metal composite oxide is about 50 mol % or more.

7. An energy storage apparatus comprising the energy storage device according to claim 1.
